(19) United States
(12) Patent Application Publication
(10) Pub. No.: US 2023/0308157 A1
(43) Pub. Date: Sep. 28, 2023

(54) BEAM SWITCHING IN SENSING-ASSISTED MIMO

(71) Applicant: HUAWEI TECHNOLOGIES CO., LTD., SHENZHEN (CN)

(72) Inventors: XIAOYAN BI, Shenzhen (CN); JIANGLEI MA, Kanata (CA); DAGENG CHEN, Kanata (CA); WEN TONG, Kanata (CA); PEIYING ZHU, Kanata (CA)

(21) Appl. No.: 18/327,480

(22) Filed: Jun. 1, 2023

Related U.S. Application Data
(63) Continuation of application No. PCT/CN2020/139126, filed on Dec. 24, 2020.

(51) Int. Cl. H04B 7/06

(52) U.S. Cl. CPC H04B 7/0695

(57) ABSTRACT

Some embodiments of the present disclosure provide a transmit receive point (TRP) with sensing abilities. Through sensing over time, the TRP can obtain details of past locations of a user equipment (UE) and a current location of the UE. Furthermore, the TRP can predict a future location for the UE. Accordingly, the TRP can proactively arrange for switching of beam directions used for both downlink channels and uplink channels.

### CROSS REFERENCE

This application is a continuation of International Application No. PCT/CN2020/139126, filed on Dec. 24, 2020, the disclosure of which is hereby incorporated by reference in its entirety.

### TECHNICAL FIELD

The present disclosure relates generally to sensing-assisted MIMO and, in particular embodiments, to beam switching in sensing-assisted MIMO.

### BACKGROUND

During communication between a transmit receive point (TRP) and a user equipment (UE), movement of the UE may cause a deterioration in the quality of the communications between the TRP and the UE. Typically, the deterioration is mitigated by taking measurements and performing training to obtain a new transmit beam direction and a new receive beam direction. Unfortunately, the measurement and training introduce overhead and latency to the task of switching beams to obtain better quality communication.

### SUMMARY

Through the use of sensing, a transmit receive point (TRP) can obtain details of past locations of a user equipment (UE) and a current location of the UE. Furthermore, the TRP can predict a future location for the UE. Accordingly, the TRP can proactively arrange for switching of beam directions used for both downlink channels and uplink channels.

By proactively arranging beam switching, the latency involved in performing beam switching in a reactive manner may be minimized. Furthermore, the beam switching can be arranged to occur before communication quality deteriorates. This point can greatly reduce the latency. By replacing training with sensing, overhead is reduced.

According to an aspect of the present disclosure, there is provided a method. The method includes transmitting a beam switching instruction. The beam switching instruction includes an indication of a first beam direction for a physical channel, the indication using coordinate information, the coordinate information expressed relative to a predefined coordinate system and a time offset indication allowing for a determination of a future moment. The method further includes, before the future moment, communicating using a second beam direction and, after the future moment, communicating using a third beam direction, the third beam direction corresponding to the first beam direction.

According to an aspect of the present disclosure, there is provided a device. The device includes a memory storing instructions and a processor. The processor is configured, by executing the instructions, to transmit a beam switching instruction. The beam switching instruction includes an indication of a first beam direction for a physical channel, the indication using coordinate information, the coordinate information expressed relative to a predefined coordinate system and a time offset indication allowing for a determination of a future moment. The processor is further configured, by executing the instructions, to communicate, before the future moment, using a second beam direction and communicate, after the future moment, using a third beam direction, the third beam direction corresponding to the first beam direction.

According to an aspect of the present disclosure, there is provided a method. The method includes receiving a beam switching instruction. The beam switching instruction includes an indication of a first beam direction for a physical channel, the indication using coordinate information, the coordinate information expressed relative to a predefined coordinate system and a time offset indication allowing for a determination of a future moment. The method further includes, before the future moment, communicating using a second beam direction and, after the future moment, communicating using a third beam direction, the third beam direction corresponding to the first beam direction.

According to an aspect of the present disclosure, there is provided a device. The device includes a memory storing instructions and a processor. The processor is configured, by executing the instructions, to receive a beam switching instruction. The beam switching instruction includes an indication of a first beam direction for a physical channel, the indication using coordinate information, the coordinate information expressed relative to a predefined coordinate system and a time offset indication allowing for a determination of a future moment. The processor is configured, by executing the instructions, to communicate, before the future moment, using a second beam direction and communicate, after the future moment, using a third beam direction, the third beam direction corresponding to the first beam direction.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates a sequence of rotations that relate a global coordinate system to a local coordinate system;

FIG. 6 illustrates spherical angles and spherical unit vectors;

FIG. 7 illustrates a two-dimensional planar antenna array structure of dual-polarized antenna;

FIG. 8 illustrates a two-dimensional planar antenna array structure of single polarization antenna;

FIG. 9 illustrates a grid of spatial zones, allowing for spatial zones to be indexed;

FIG. 10, illustrates, in a signal flow diagram, example steps in a known procedure of beam switching for various physical channels;

FIG. 11 illustrates, in a signal flow diagram, a beam switching procedure in accordance with aspects of the present application;

FIG. 12, illustrates, in a signal flow diagram, example steps in a known procedure of beam switching for various physical channels;

FIG. 13 illustrates, in a signal flow diagram, a beam switching procedure in accordance with aspects of the present application;

FIG. 14 illustrates, in a signal flow diagram, a beam switching procedure in accordance with aspects of the present application;

FIG. 15 illustrates, in a signal flow diagram, a beam switching procedure in accordance with aspects of the present application;

FIG. 16 illustrates, in a signal flow diagram, a beam switching procedure in accordance with aspects of the present application;

FIG. 17 illustrates, in a signal flow diagram, a beam switching procedure in accordance with aspects of the present application;

FIG. 18 illustrates, in a signal flow diagram, a beam switching procedure in accordance with aspects of the present application;

FIG. 19 illustrates, in a signal flow diagram, a beam switching procedure in accordance with aspects of the present application;

FIG. 20 illustrates, in a signal flow diagram, a beam switching procedure in accordance with aspects of the present application;

FIG. 21 illustrates, in a signal flow diagram, a beam switching procedure in accordance with aspects of the present application;

FIG. 22 illustrates, in a signal flow diagram, a beam switching procedure in accordance with aspects of the present application; and

FIG. 23 illustrates, in a signal flow diagram, a beam switching procedure in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

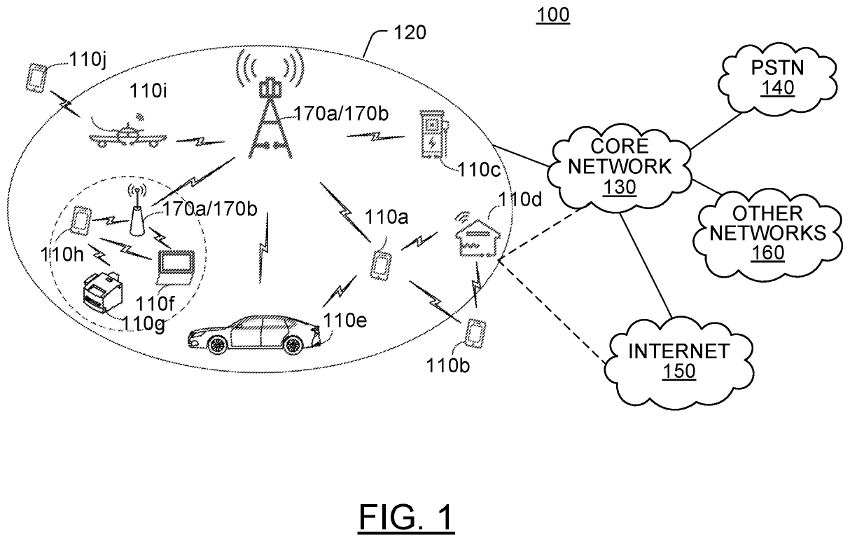

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

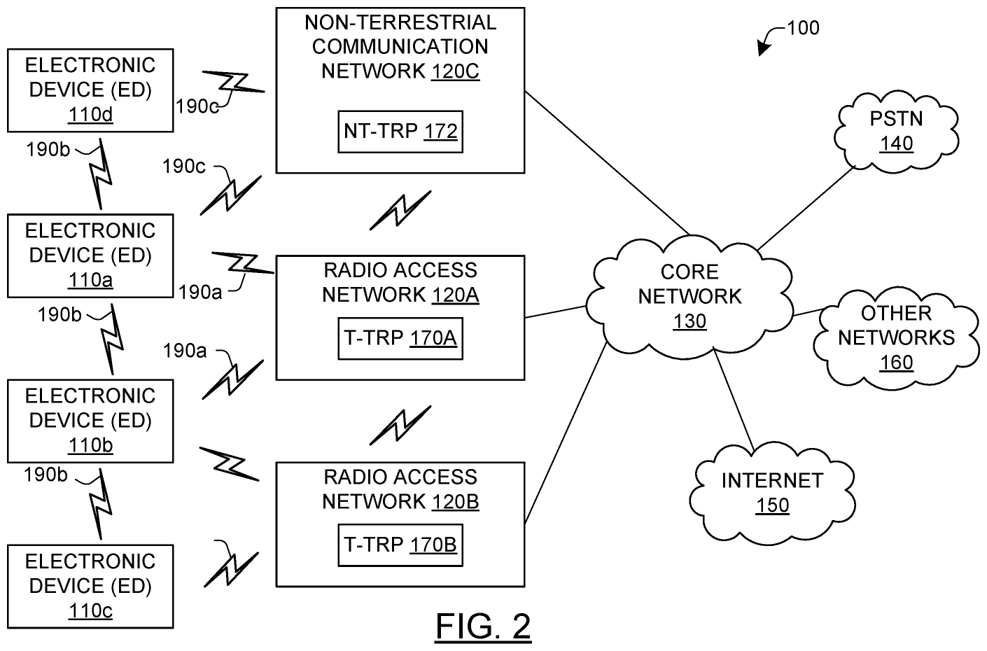

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

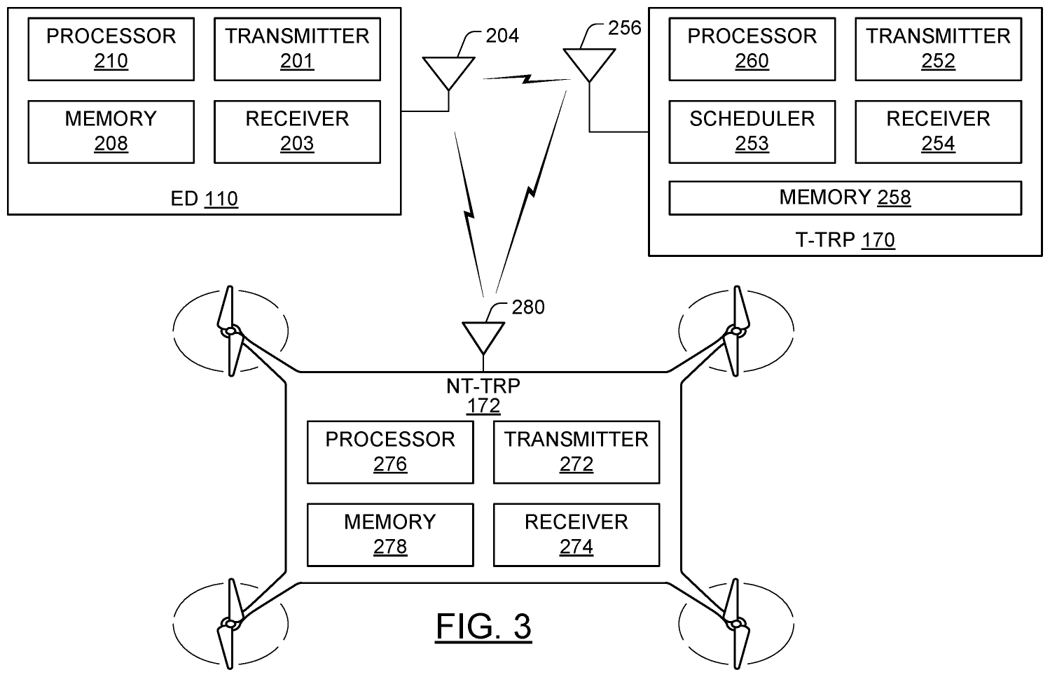

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

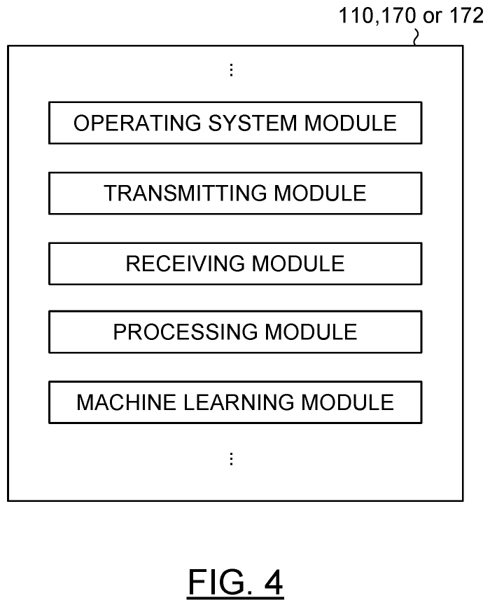

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

Going to the future wireless network, the number of the new devices could be increased exponentially with diverse functionalities. Also, a lot more new applications and use cases than those associated with 5G may emerge with more diverse quality of service demands. These use cases will result in new key performance indications (KPIs) for the future wireless networks (for an example, 6G network) that can be extremely challenging. It follows that sensing technologies and artificial intelligence (AI) technologies, especially machine learning and deep learning technologies, are being introduced to telecommunication for improving the system performance and efficiency.

AI technologies may be applied to communication systems. In particular AI technologies may be applied to communication in Physical layer and to communication in media access control (MAC) layer.

For the physical layer, the AI technologies may be employed to optimize component design and improve algorithm performance. For example, AI technologies may be applied to channel coding, channel modelling, channel estimation, channel decoding, modulation, demodulation, MIMO, waveform, multiple access, PHY element parameter optimization and update, beam forming and tracking and sensing and positioning, etc.

For the MAC layer, AI technologies may be utilized in the context of learning, predicting and making decisions to solve complicated optimization problems with better strategy and optimal solution. For one example, AI technologies may be utilized to optimize the functionality in MAC for, e.g., intelligent TRP management, intelligent beam management, intelligent channel resource allocation, intelligent power control, intelligent spectrum utilization, intelligent modulation and coding scheme selection, intelligent HARQ strategy, intelligent transmit/receive mode adaption, etc.

AI architectures usually involve multiple nodes. The multiple nodes can be organized in two modes, i.e., a centralized mode and a distributed mode, both of which modes can be deployed in an access network, a core network or an edge computing system or third network. A centralized training and computing architecture is restricted by communication overhead and strict user data privacy. Distributed training and computing architecture may be organized according to several frameworks, e.g., distributed machine learning and federated learning. AI architectures include an intelligent controller, which can perform as a single agent or as a multi-agent, based on joint optimization or individual optimization. New protocols and signaling mechanisms may be established so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent context-aware networks to enhance the UE experience. For an example, terrestrial network-based sensing and non-terrestrial network-based sensing may be shown to provide opportunities for localization applications and sensing applications based on new sets of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial networks and in non-terrestrial networks, the measured channel data and sensing and positioning data can be obtained by large bandwidth, new spectrum, dense network and more light-of-sight (LOS) links. Based on these data, a radio environmental map can be drawn through AI methods, where channel information is linked, in the map, to its corresponding positioning, or environmental information, to, thereby, provide an enhanced physical layer design based on this map.

Sensing coordinators are nodes in a network that can assist in the sensing operation. These nodes can be stand-alone nodes dedicated to just sensing operations or other nodes (for example, the T-TRP 170, the ED 110, or a node in the core network 130) doing the sensing operations in parallel with communication transmissions. New protocol and signaling mechanism is needed so that the corresponding interface link can be performed with customized parameters to meet particular requirements while minimizing signaling overhead and maximizing the whole system spectrum efficiency.

AI and sensing methods are data hungry. In order to involve AI and sensing in wireless communications, more and more data are needed to be collected, stored and exchanged. The characteristics of wireless data are known to expand to large ranges in multiple dimensions, e.g., from sub-6 GHz, millimeter to Terahertz carrier frequency, from space, outdoor to indoor scenario, and from text, voice to video. These data are collecting, processing and usage are performed in a unified framework or a different framework.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high-altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

As one of key technologies of NR, MIMO can further improve a system capacity by using more spatial degrees of freedom.

Beam management is one of the elements of successful use of MIMO. In typical beam management schemes, a weight of an antenna (port), in a multi-antenna system, may be adjusted so that energy in the transmitted signals is directional. That is, the energy is aggregating in a certain direction. Such an aggregation of energy is typically called a beam. For NR, the entire air interface is designed based on beams; uplink channels are transmitted on beams; and downlink channels are received on beams. Beam management relates to establishing and retaining a suitable beam pair. A beam pair includes a transmitter-side beam with a transmitter-side beam direction and a corresponding receiver-side beam with a receiver-side beam direction. When implemented appropriately, a beam pair jointly provides good connectivity. Aspects of beam management include initial beam establishment, beam adjustment and beam recovery. Further aspects of beam management include beam selection, beam measurement, beam reporting, beam switching, beam indication, etc.

In the research of beam management, beam switching is an important issue. Once an initial beam pair has been established, a regular reevaluation of the selection of the transmitter-side beam direction and the receiver-side beam direction may be seen as useful in view of movements and rotations of the UE 110. If monitoring of the transmission quality of an existing beam pair indicates deterioration, the TRP 170 and the UE 110 may be prompted to select another beam pair with better quality. In current NR beam switching methods, determining an updated beam pair depends on beam measurement, transmitter-side beam training and/or receiver-side beam training. The updated beam pair may be indicated by a quasi-colocation-based (QCL-based) beam indication method. In RRC_CONNECTED mode, CSI-RS/SSB may be used for beam training in the downlink direction and SRS may be used for beam training in the uplink direction. As beam training and measurement are relatively time-consuming, current beam switching methods have a disadvantage of a relatively large latency.

Beam indication is an important component of beam switching. In current methods, the updated beam pair is indicated by a QCL-based beam indication method. QCL-based beam indication methods generally indicate a relationship between the target beam and the source reference beam. These two beams are considered to be QCL, which means that the features of the target beam can be deduced from the features of the source reference beam. After an RRC connection has been established, a Transmission Configuration Indicator (TCI) state may be used to associate a corresponding QCL type of one or two DL reference signals (e.g., SSB, CSI-RS, etc.). The known QCL-based beam indication method has several points of disadvantage. The first point is that the known QCL-based beam indication method can only indicate that the target RS and the source RS have a relationship with the same feature but cannot indicate other relationships. The second point is that the known QCL-based beam indication method requires source reference beams. Notably, the source reference beams need to be pre-trained and measured, resulting in a relatively large latency and relatively large overhead. With the increasing number of UEs 110 in future wireless communication networks, the overheads of beam training may be expected to increase sharply due to an increase in a quantity of training or measurement beams. The third point is that the known QCL-based beam indication method cannot directly indicate a physical direction relationship between beams.

In NR, beam switching belongs to a category of passive beam management. In contrast, it is expected that, in 6G, a proactive, UE-centric beam switching management method will be established. Future wireless communication networks are expected to have an increasing requirement on low latency for beam switching. Furthermore, agile and direct beam indication may be seen as beneficial to the task of achieving low-latency beam switching.

It is understood that modern developments in the area of sensing technology will give devices in a 6G network environmental awareness. In this way, information such as the location, the angle of arrival (AOA) and the angle of departure (AOD) of a connection to a given UE 110 can be easily obtained through the use of sensing signals to obtain sensing information. If the given UE 110 is moving or rotating, the TRP 170 may predict a preferred new beam direction on the basis of the sensing information and/or AI technology. Such an ability to predict may be expected to help achieve low-latency beam switching. Aspects of the present application propose methods for beam switching that include the help of the sensing signal.

In overview, according to aspects of the present application, the TRP 170 may proactively perform beam switching by predicting a reason for a change in beam direction caused, for example, by movement and/or rotation of the UE 110. The TRP 170 may accomplish such a prediction of a reason for a change in beam direction through the use of sensing signals and/or AI technology and/or channel measurements and/or channel monitoring. Indication of beam direction may be performed using coordinate-based beam indication method. This coordinate-based beam direction indication method directly indicates beam direction based on a predetermined coordinate system.

Aspects of the present application support beam switching in both downlink communication and uplink communication.

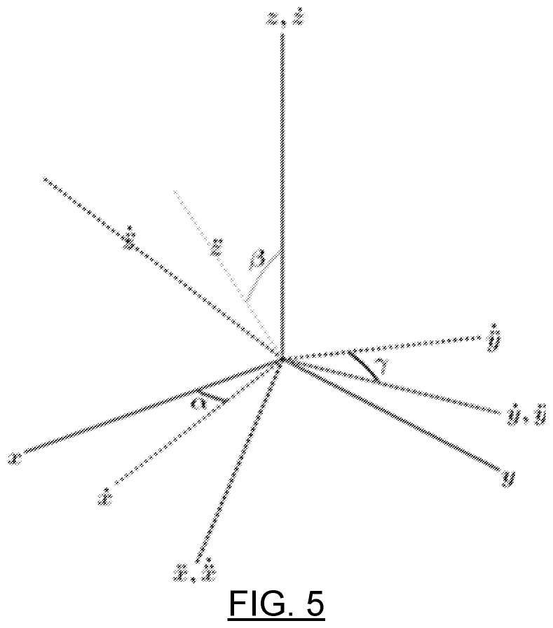

Initially, a global coordinate system (GCS) and multiple local coordinate systems (LCS) may be defined. The GCS may be a global unified geographical coordinate system or a coordinate system comprising of only some TRPs 170 and UEs 110, defined by the RAN. From another perspective, GCS may be UE-specific or common to a group of UEs. An antenna array for a TRP 170 or a UE 110 can be defined in a Local Coordinate System (LCS). An LCS is used as a reference to define the vector far-field that is pattern and polarization, of each antenna element in an array. The placement of an antenna array within the GCS is defined by the translation between the GCS and an LCS. The orientation of the antenna array with respect to the GCS is defined in general by a sequence of rotations. The sequence of rotations may be represented by the set of angles α, β and γ. The set of angles {α, β, γ} can also be termed as the orientation of the antenna array with respect to the GCS. The angle α is called the bearing angle, β is called the downtilt angle and γ is called the slant angle. FIG. 5 illustrates the sequence of rotations that relate the GCS and the LCS. In FIG. 5, an arbitrary 3D-rotation of the LCS is contemplated with respect to the GCS given by the set of angles {α, β, γ}. The set of angles {α, β, γ} can also be termed as the orientation of the antenna array with respect to the GCS. Any arbitrary 3-D rotation can be specified by at most three elemental rotations and, following the framework of FIG. 5, a series of rotations about the z, \dot{y} and \ddot{x} axes are assumed here, in that order. The dotted and double-dotted marks indicate that the rotations are intrinsic, which means that they are the result of one (.) or two (..) intermediate rotations. In other words, the \dot{y} axis is the original y axis after the first rotation about the z axis and the \ddot{x} axis is the original x axis after a first rotation about the z axis and a second rotation about the \dot{y} axis. A first rotation of α about the z axis sets the antenna bearing angle (i.e., the sector pointing direction for a TRP antenna element). The second rotation of β about the 9 axis sets the antenna downtilt angle.

Finally, the third rotation of γ about the \ddot{x} axis sets the antenna slant angle. The orientation of the x, y and z axes after all three rotations can be denoted as [symbol] , [symbol] and [symbol] . These triple-dotted axes represent the final orientation of the LCS and, for notational purposes, may be denoted as the x′, y′ and z′ axes (local or “primed” coordinate system).

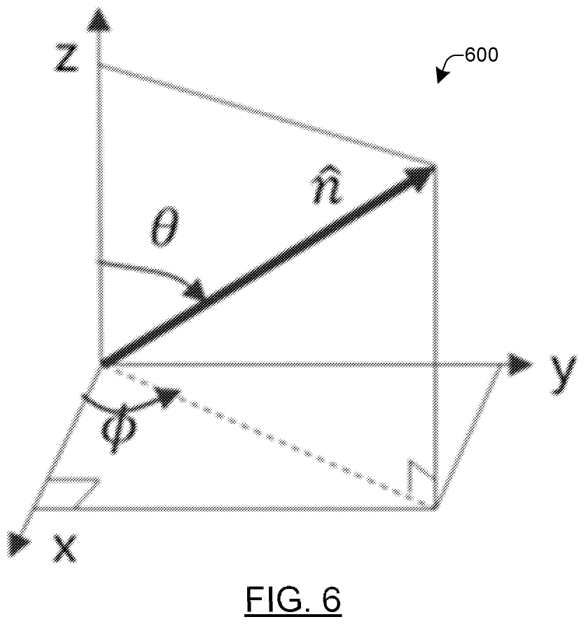

A coordinate system is defined by the x, y and z axes, the spherical angles and the spherical unit vectors as illustrated in FIG. 6. A representation 600 in FIG. 6 defines a zenith angle θ and the azimuth angle ϕ in a Cartesian coordinate system. R is the given direction and the zenith angle, θ, and the azimuth angle, ϕ, may be used as the relative physical angle of the given direction. Note that θ=0 points to the zenith and ϕ=0 points to the horizon.

A method of converting the spherical angles (θ, ϕ) of the GCS into the spherical angles (θ′, ϕ′) of the LCS according to the rotation operation defined by the angles α, β and γ is given below.

To establish the equations for transformation of the coordinate system between the GCS and the LCS, a composite rotation matrix is determined that describes the transformation of point (x, y, z), in the GCS, into point (x′, y′, z′), in the LCS. This rotation matrix is computed as the product of three elemental rotation matrices. The matrix to describe rotations about the z, \dot{y} and \ddot{x} axes by the angles α, β and γ, respectively and in that order is defined in equation (1), as follows:

$$\begin{matrix}R = {R}_{Z} ( α ) {R}_{Y} ( β ) {R}_{X} ( γ ) \\ = ( \begin{matrix}+ cos α & - sin α & 0 \\ + sin α & + cos α & 0 \\ 0 & 0 & 1\end{matrix} ) ( \begin{matrix}+ cos β & 0 & + sin β \\ 0 & 1 & 0 \\ - sin β & 0 & + cos β\end{matrix} ) ( \begin{matrix}1 & 0 & 0 \\ 0 & + cos γ & - sin γ \\ 0 & + sin γ & + cos γ\end{matrix} )\end{matrix} \qquad ( 1 )$$

The reverse transformation is given by the inverse of R. The inverse of R is equal to the transpose of R, since R is orthogonal.

R⁻¹=R_{X}(−γ)R_{Y}(−β)R_{Z}(−α)=R^{T} (2)

The simplified forward and reverse composite rotation matrices are given in equations (3) and (4).

$$R = ( \begin{matrix}cos αcosβ & cos αsinβsinγ - sin αcosγ & cos αsinβcosγ + sin αsinγ \\ sin αcosβ & sin αsinβsinγ + cos αcosγ & sin αsinβcosγ - cos αsinγ \\ - sin β & cos βsinγ & cos βcosγ\end{matrix} ) \qquad ( 3 )$$

$${R}^{- 1} = ( \begin{matrix}cos αcosβ & sin αcosβ & - sin β \\ cos αsinβsinγ - sin αcosγ & sin αsinβsinγ + cos αcosγ & cos βsinγ \\ cos αsinβcosγ + sin αsinγ & sin αsinβcosγ - cos αsinγ & cos βcosγ\end{matrix} ) \qquad ( 4 )$$

These transformations can be used to derive the angular and polarization relationships between the two coordinate systems.

In order to establish the angular relationships, consider a point (x, y, z) on the unit sphere defined by the spherical coordinates (ρ=1, θ, ϕ), where ρ is the unit radius, θ is the zenith angle measured from the +z-axis and ϕ is the azimuth angle measured from the +x-axis in the x-y plane. The Cartesian representation of that point is given by

$$\hat{p} = ( \begin{matrix}x \\ y \\ z\end{matrix} ) = ( \begin{matrix}sin θcosφ \\ sin θsinφ \\ cos θ\end{matrix} ) \qquad ( 5 )$$

The zenith angle is computed as arccos(\hat{ρ}·\hat{z}) and the azimuth angle as arg(\hat{z}·\hat{ρ}+jŷ·\hat{ρ}), where \hat{x}, ŷ and \hat{z} are the Cartesian unit vectors. If this point represents a location in the GCS defined by θ and ϕ, the corresponding position in the LCS is given by R⁻¹\hat{ρ}, from which local angles θ′ and ϕ′ can be computed. The results are given in equations (6) and (7)

$$\begin{matrix}{θ}^{′} ( α , β , γ ; θ , φ ) = {cos}^{- 1} ( {[ \begin{matrix}0 \\ 0 \\ 1\end{matrix} ]}^{T} {R}^{- 1} \hat{ρ} ) \\ = {cos}^{- 1} ( cos βcosγcosα + ( sin βcosγcos ( φ - α ) - \\ sin γsin ( φ - α ) ) sin θ )\end{matrix} \qquad ( 6 )$$

$$\begin{matrix}{ϕ}^{′} ( α , β , γ ; θ , φ ) = arg ( {[ \begin{matrix}1 \\ j \\ 0\end{matrix} ]}^{T} {R}^{- 1} \hat{ρ} ) \\ = arg ( \begin{matrix}( cos βsinθcos ( φ - α ) - sin βcosθ ) + \\ j ( cos βsinγcosθ + ( sin βsinγcos ( φ - α ) + \\ cos γsin ( φ - α ) ) sin θ )\end{matrix} )\end{matrix} \qquad ( 7 )$$

A beam link between the TRP 170 and the given UE 110 may be defined using various parameters. In the context of the local coordinate system, having the TRP 170 at the origin, the parameters may be defined to include a relative physical angle and an orientation between the TRP 170 and the given UE 110.

The relative physical angle, or beam direction “ξ,” may be used as one or two of the coordinates for the beam indication. The TRP 170 may use conventional sensing signals to obtain the beam direction, ξ, to associate with the given UE 110.

If the coordinate system is defined by the x, y and z axes, the location “(x, y, z),” of the TRP 170 or the UE 110, may be used as one or two or three of the coordinates for beam indication. The location “(x, y, z)” may be obtained through the use of sensing signals.

The beam direction may contain a value representative of a zenith of an angle of arrival, a value representative of a zenith of an angle of departure, a value representative of an azimuth of an angle of arrival or an azimuth of an angle of departure.

A boresight orientation may be used as one or two of the coordinates for the beam indication. Additionally, a width may be used as one or two of the coordinates for the beam indication.

Location information and orientation information for the TRP 170 may be broadcast to all UEs 110 in communication range of the TRP 170. In particular, the location information for the TRP 170 may be included in the known System Information Block 1 (SIB1). Alternatively, the location information for the TRP 170 may be included as part of a configuration of the given UE 110.

According to the absolute beam indication aspects of the present application, when providing a beam indication to the given UE 110, the TRP may indicate the beam direction, ξ, as defined in the local coordinate system.

In contrast, according to the differential beam indication aspects of the present application, when providing a beam indication to the given UE 110, the TRP may indicate the beam direction using differential coordinates, Δξ, relative to a reference beam direction. Of course, this approach relies on both the TRP 170 and the given UE 110 having been configured with the reference beam direction.

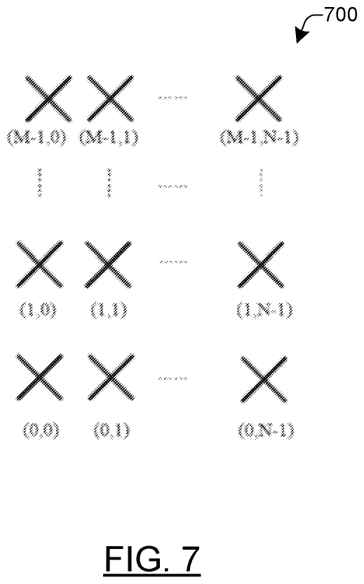

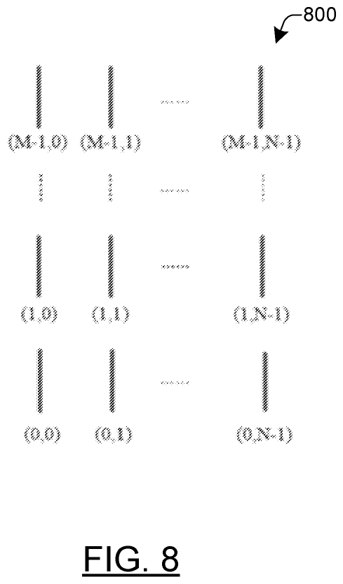

The beam direction could also be defined according to predefined spatial grids. FIG. 7 illustrates a two-dimensional planar antenna array structure 700 of a dual polarized antenna. FIG. 8 illustrates a two-dimensional planar antenna array structure 800 of a single polarized antenna. Antenna elements may be placed in vertical and horizontal directions as illustrated in FIGS. x and γ, where N is the number of columns and M is the number of antenna elements with the same polarization in each column. The radio channel between the TRP 170 and the UE 110 may be segmented into multiple zones. Alternatively, the physical space between the TRP 170 and the UE 110 may be segmented into 3D zones, wherein multiple spatial zones include the zones in vertical and horizontal directions.

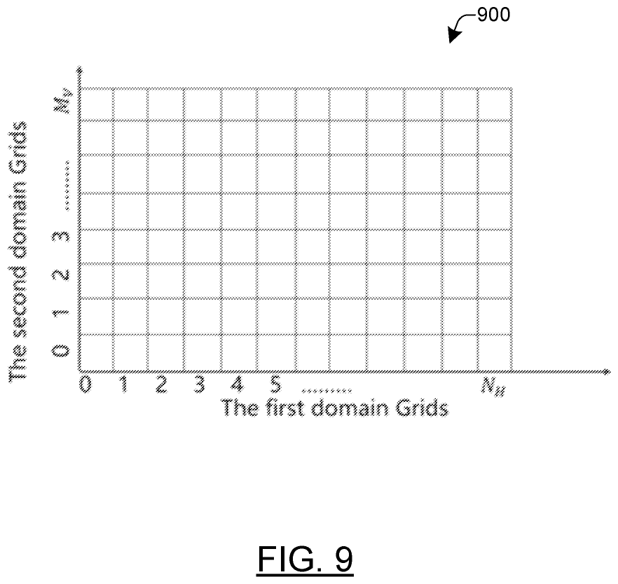

With reference to a grid 900 of spatial zones illustrated in FIG. 9, a beam indication may be an index of a spatial zone, for example, the index of the grids. Here N_{H} can be same or different as the N of the antenna array, My could be same or different as the M of the antenna array. For an X-pol antenna array, the beam direction of the two polarization antenna array can be indicated independently or by a single indication. Each of the grid is corresponding to a vector in column and a vector in row, which are generated by partial or full of the antenna array. Such beam indication in spatial domain may be indicated by the combination of a spatial domain beam and a frequency domain vector. Further, beam indication may be a one dimensional index of the spatial zone (X-pol antenna array or Y-pol antenna array). In addition, a beam indication may be the three dimension index of the spatial zone (X-pol antenna array and Y-pol antenna array and Z-pol antenna array).

Assuming that the UE 110 is moving, the TRP 170 may monitor for a change in the position of the UE 110. Upon detecting a change in the position of the UE 110, the TRP 170 may predict Tx/Rx (transmit/receive) beam direction at the TRP 170 side, based on sensing and/or based on AI technology and/or based on channel measurements and/or based on channel monitoring.

In particular, the TRP 170 may predict a new Tx beam direction for PDCCH/PDSCH/CSI-RS and the TRP 170 may predict a new Rx beam direction for PUCCH/PUSCH/SRS.

At a first moment, t₁, the TRP 170 may predict that communication quality of an existing beam pair will deteriorate at a future moment, t₂. The TRP 170 may benefit from updating to a new Tx/Rx beam direction to maintain good communication beyond the future moment, t₂. Accordingly, the TRP 170 may initiate a beam switching procedure.

Beam switching according to aspects of the present application may be shown to support both downlink and uplink communication.

A beam switching threshold may be pre-configured such that the TRP 170 may only initiate a beam switching procedure responsive to determining that a predicted new beam direction satisfies a criteria represented by the beam switching threshold. For example, the beam switching threshold may be pre-configured to a value that is half of an angle corresponding to an m-dB beamwidth horizontal and/or n-dB beamwidth vertical. m-dB or n-dB beamwidth refers to angle between two directions where the radiated power is m dB or n dB lower than the maximum radiated power, wherein the m or n is a positive real number, and the m or n is larger than 0, m can be equal to or not equal to n. Upon determining that the angle between the new beam direction and the existing beam direction exceeds the beam switching threshold, the TRP 170 may initiate a beam switching procedure. For example, the beam switching threshold may be pre-configured to be the metric values related to the beam quality, such as reference signal received power (RSRP) and/or signal-to-noise ratio (SNR) and/or signal-to-interference-and-noise ratio (SINR). The beam quality can be obtained by AI prediction or reference-signal-based measurement or given beams. Upon determining that the beam quality of the existing beam direction falls below the beam switching threshold, the TRP 170 may initiate a beam switching procedure. For example, the beam switching threshold may be pre-configured, which includes both of the above two thresholds, m-dB beamwidth and beam quality.

As part of the beam switching procedure, the TRP 170 may transmit a beam update indication to the UE 110. The TRP 170 may instruct the UE 110 to adjust the UE beam direction at the future moment, t₂, which may be defined by a time offset, Δt, or at a moment at which a physical channel or a signal is transmitted after the future moment, t₂, so that the UE beam direction may be aligned with the TRP beam direction. In addition to providing the instruction to the UE 110, the TRP 170 may update the Tx beam direction for the PDCCH/PDSCH/CSI-RS and/or update the Rx beam direction for PUCCH/PUSCH/SRS.

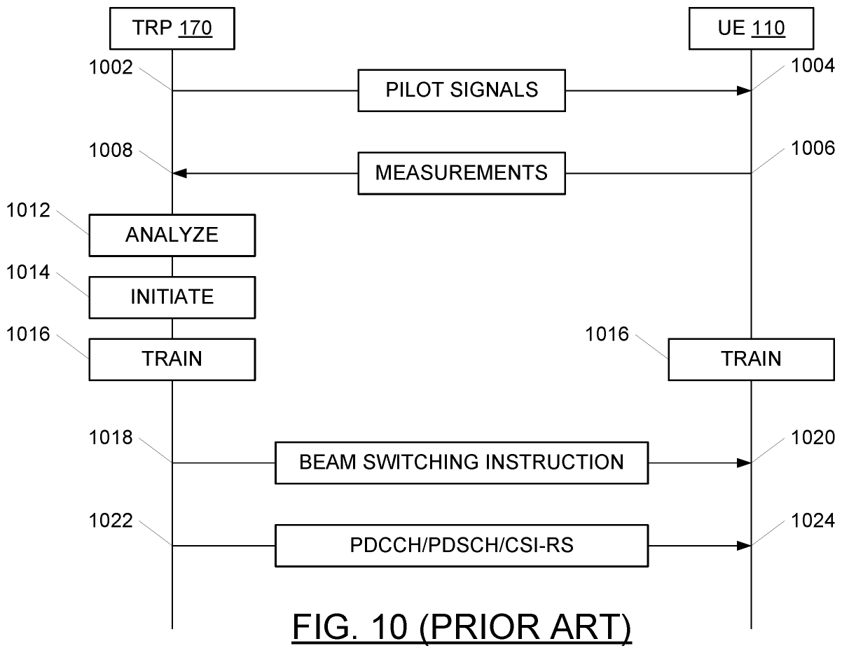

FIG. 10, illustrates, in a signal flow diagram, example steps in the known (NR) procedure of beam switching for PDSCH and/or PDCCH and/or CSI-RS.

It is typical for the TRP 170 to transmit (step 1002) pilot signals in periodic, aperiodic or semi-persistent mode. The TRP 170 may, for one example, transmit (step 1002) CSI-RSs.

The UE 110 receives (step 1004) the pilot signals and obtains measurements of the quality of the communication link over which the pilot signals have been received (step 1004). The measurements may be expressed using metrics. One example metric is layer 1 (L1) reference signal received power (RSRP).

The UE 110 transmits (step 1006), to the TRP 170, a report indicating the obtained measurements. It is typical for the UE 110 to report the measurements in periodic, aperiodic or semi-persistent way.

The TRP 170 receives (step 1008) the report.

Upon analyzing (step 1012) the metrics received (step 1008) in the report, the TRP 170 may recognize that the quality of the communication link between the TRP 170 and the UE 110 is poor.

Responsive to the TRP 170 recognizing that the quality of the communication link is poor, the TRP 170 may initiate (step 1014) a beam switching procedure.

Responsive to the initiation (step 1014) of the beam switching procedure, beam training is performed (step 1016). The beam training (step 1016) may include transmit-side beam training and/or receive-side beam training.

A result of performing (step 1016) beam training is that the TRP 170 obtains a new transmit beam direction and a corresponding new receive beam direction.

After obtaining the new beam directions, the TRP 170 transmits (step 1018), to the UE 110, an instruction to perform beam switching. The transmission (step 1018) of the instruction may be accomplished using Media Access Control-Channel Element (MAC-CE), DCI, RRC configuration, etc.

The instruction may indicate the new receive beam direction using a QCL-based beam indication.

Subsequent to transmitting (step 1018) the beam switching instruction, the TRP 170 may communicate (step 1022) with the UE 110 using PDSCH and/or PDCCH and/or CSI-RS and the new transmit beam direction.

Responsive to receiving (step 1020) the beam switching instruction, the UE 110 may apply the new receive beam direction to the task of receiving (step 1024) the communication from the TRP 170.

The known (NR) method of beam switching summarized in the signal flow diagram of FIG. 10 has a relatively large latency, due to the beam training (step 1016). In addition, the known (NR) method of beam switching may be considered to belong to a category of beam switching called “passive beam switching.” In passive beam switching, the initiation (step 1014) of the beam switching occurs responsive to measurement of poor communication link quality and cannot be predicted in advance. This reactive approach may also be seen as a cause of latency.

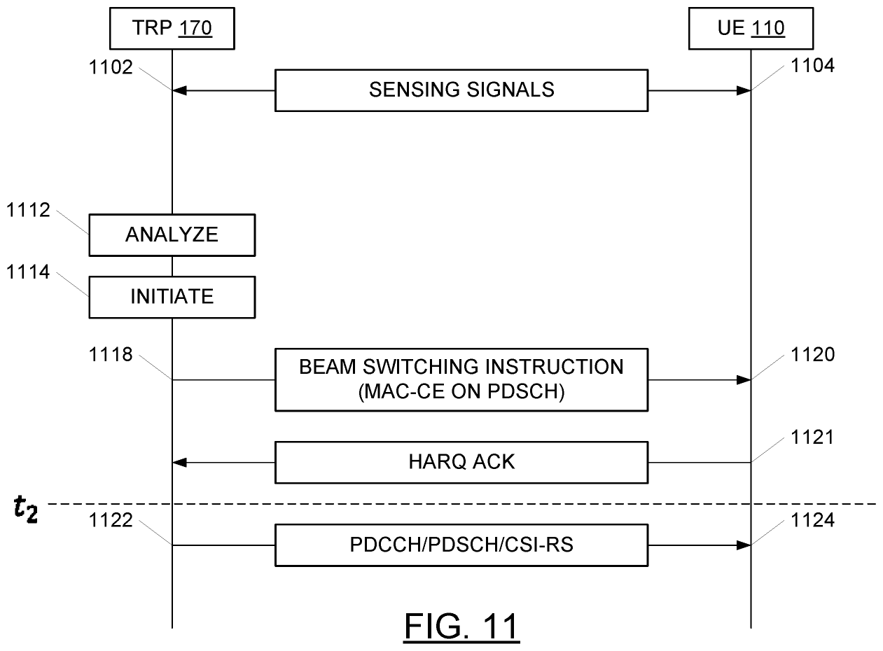

FIG. 11 illustrates, in a signal flow diagram, a beam switching procedure in accordance with aspects of the present application.

It has been discussed hereinbefore that a coordinate system may be predetermined. It has been also been discussed hereinbefore that location information and orientation information for the TRP 170 may be broadcast to all UEs 110 in communication range of the TRP 170. In particular, the location information and orientation information for the TRP 170 may be included in a SIB1 or in a SIBx or configured by the TRP in RRC signaling. The location information and orientation information may be represented in the predetermined coordinate system.

One aspect of predicting a reason for initiating a beam switching procedure involves the TRP 170 monitoring the location of the UE 110.

Options for monitoring the location of the UE 110 may include the use of AI technology and the use of sensing signals.

In one approach to the use of sensing signals, the TRP 170 or the UE 110 transmits (step 1102) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or TRP 170 transmits (step 1104) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 1102 and step 1104 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1112) versions of the sensed environment obtained through temporally separated transmissions (steps 802 and/or 804) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1112) obtaining information about the present location of the UE 110 and past locations of the UE 110, the TRP 170 may use the analyzing (step 1112) to attempt to predict a future location for the UE 110. It is in the attempt to predict a future location for the UE 110 that the TRP may employ AI technology. One result of the analyzing (step 1112) may be a future location for the UE 110. Another result of the analyzing (step 1112) may be a selection of a new transmit beam direction for use, by the TRP 170, when transmitting to the UE 110 when the UE 110 is in the future location. On the basis of trends recognized in the analyzing (step 1112), the TRP 170 may predict that the quality of the communication link between the TRP 170 and the UE 110 will deteriorate at a future moment, t₂. That is, a further result of the analyzing (step 1112) may be a prediction of the future moment, t₂, at which the new transmit beam direction is expected to provide a more robust communication link than the existing transmit beam direction.

A beam switching threshold may be pre-configured such that the TRP 170 may only initiate (step 1114) a beam switching procedure responsive to determining (step 1112) that a predicted new transmit beam direction satisfies a criteria represented by the beam switching threshold. For example, the beam switching threshold may be pre-configured to a value that is half of an angle corresponding to an m-dB beamwidth horizontal and/or n-dB beamwidth vertical. m-dB or n-dB beamwidth refers to angle between two directions where the radiated power is m dB or n dB lower than the maximum radiated power, wherein the m or n is a positive real number and the m or n is larger than 0, m can be equal to or not equal to n. Upon determining (step 1112) that the angle between the new transmit beam direction and the existing transmit beam direction exceeds the beam switching threshold, the TRP 170 may initiate (step 1114) a beam switching procedure. For example, the beam switching threshold may be pre-configured to be the metric values related to the beam quality, such as RSRP and/or SNR and/or SINR. The beam quality can be obtained by AI prediction or reference-signal-based measurement or given beams. Upon determining that the beam quality of the existing beam direction falls below the beam switching threshold, the TRP 170 may initiate a beam switching procedure. For example, the beam switching threshold may be pre-configured, which includes both of the above two thresholds, m-dB beamwidth and beam quality.

Responsive to initiating (step 1114) the beam switching procedure, the TRP 170 transmits (step 1118), to the UE 110, an instruction to perform beam switching. The transmission (step 1118) of the instruction may be accomplished using a MAC-CE on the PDSCH. The instruction may include a beam indication for a new receive beam direction corresponding to the new transmit beam direction and an indication of the future time at which the switch to the new transmit beam direction will occur at the TRP 170.

The indication of the future time may take the form of a time offset (Δt). The future moment, t₂, at which the new transmit beam direction is to be employed by the TRP 170 may be determined, at the UE 110, by combining the time offset, Δt, which has been received (step 1120) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. Alternatively, the reference time point, t_{ref}, may be transmitted (step 1118) as part of the beam switching instruction.

The instruction may indicate the new receive beam direction using a coordinate-based beam indication. The instruction may indicate the new receive beam direction as an absolute beam direction by using coordinates. Alternatively, the instruction may indicate the new receive beam direction using a differential representation of the new receive beam direction in the context of a reference beam direction by using differential coordinates. The reference beam direction may be related to the beam direction used, by the TRP 170, to transmit (step 1102) the sensing signals.

Notably, the new transmit beam may not be transmitted (step 1122) by the TRP 170. Indeed, the new transmit beam may be transmitted (step 1122) by a distinct TRP 170 defining a neighboring cell.

Typically, but not always, the TRP 170 will select (part of step 1112) the new transmit beam direction from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 1112) from among the transmit beam directions in the pre-configured transmit beam pool.

Responsive to receiving (step 1120) the beam switching instruction, the UE 110 may transmit (step 1121) an acknowledgement (e.g., a HARQ ACK) to the TRP 170 to acknowledge receipt of the switching instruction.

Subsequent to transmitting (step 1118) the beam switching instruction, the TRP 170 may wait until the specified future moment, t₂, or the specified moment at which a PDSCH or PDCCH or CSI-RS is transmitted after the future moment, t₂, to apply the new transmit beam direction to the task of communicating (step 1122) with the UE 110 using PDSCH or PDCCH or CSI-RS.

Responsive to receiving (step 1120) the beam switching instruction, the UE 110 may wait until the specified future moment, t₂, or the specified moment at which the PDSCH or PDCCH or CSI-RS is transmitted after the future moment, t₂, to apply the new receive beam direction to the task of receiving (step 1124) the communication from the TRP 170.

For PDCCH transmission, if a PDCCH transmission (step 1122) is to be performed at the future moment, t₂, the TRP 170 is to apply the new transmit beam direction to the PDCCH transmission (step 1122) at the future moment, t₂. If a PDCCH transmission (step 1122) is to be performed after the future moment, t₂, the TRP 170 is to apply the new transmit beam direction to the PDCCH transmission (step 1122) after the future moment, t₂.

For PDSCH transmission, if a PDSCH transmission (step 1122) is to be performed at the future moment, t₂, the TRP 170 is to apply the new transmit beam direction to the PDCCH transmission (step 1122) at the future moment, t₂. If a PDSCH transmission (step 1122) is to be performed after the future moment, t₂, the TRP 170 is to apply the new transmit beam direction to the PDSCH transmission (step 1122) after the future moment, t₂.

For CSI-RS transmission in periodic and/or aperiodic and/or semi-persistent mode, if a CSI-RS transmission (step 1122) is to be performed at the future moment, t₂, the TRP 170 is to apply the new transmit beam direction to the CSI-RS transmission (step 1122) at the future moment, t₂. If a CSI-RS transmission (step 1122) is to be performed after the future moment, t₂, the TRP 170 is to apply the new transmit beam direction to the CSI-RS transmission (step 1122) after the future moment, t₂.

In contrast to the reactive method presented in FIG. 10, the method presented in FIG. 11 may be considered to be a proactive method. By means of prediction, the UE 110 can be notified, in advance, of a plan to perform beam switching at a specific moment, before communication quality deteriorates.

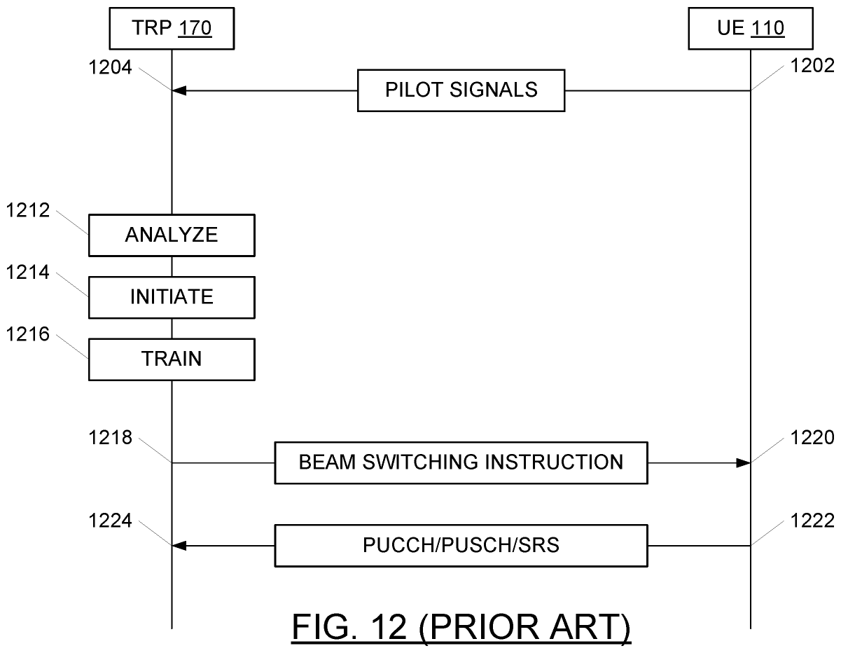

FIG. 12, illustrates, in a signal flow diagram, example steps in the known (NR) procedure of beam switching for PUSCH and/or PUCCH and/or SRS.

It is typical for the UE 110 to transmit (step 1202) pilot signals in periodic, aperiodic or semi-persistent mode. The UE 110 may, for one example, transmit (step 1202) SRSs.

The TRP 170 receives (step 1204) the pilot signals and obtains measurements of the quality of the communication link over which the pilot signals have been received (step 1204). The measurements may be expressed using metrics. One example metric is L1 RSRP.

Upon analyzing (step 1212) the metrics, the TRP 170 may recognize that the quality of the communication link between the UE 110 and the TRP 170 is poor.

Responsive to the TRP 170 recognizing that the quality of the communication link is poor, the TRP 170 may initiate (step 1214) a beam switching procedure.

Responsive to the initiation (step 1214) of the beam switching procedure, beam training is performed (step 1216). The beam training (step 1216) may include transmit-side beam training and/or receive-side beam training.

A result of performing (step 1216) beam training is that the TRP 170 obtains a new receive beam direction and a corresponding new transmit beam direction.

After obtaining the new beam directions, the TRP 170 transmits (step 1218), to the UE 110, an instruction to perform beam switching. The transmission (step 1218) of the instruction may be accomplished using MAC-CE, DCI, RRC configuration, etc.

The instruction may indicate the new transmit beam direction using a QCL-based beam indication.

Responsive to receiving (step 1220) the beam switching instruction, the UE 110 may apply the new transmit beam direction to the task of communicating (step 1222) with the TRP 170 using PUSCH and/or PUCCH and/or SRS and the new transmit beam direction.

Subsequent to transmitting (step 1218) the beam switching instruction, the TRP 170 may receive (step 1224) communication from the UE 110 using the new receive beam direction.

The known (NR) method of beam switching summarized in the signal flow diagram of FIG. 12 has a relatively large latency, due to the beam training (step 1216). In addition, the known (NR) method of beam switching may be considered to belong to a category of beam switching called “passive beam switching.” In passive beam switching, the initiation (step 1214) of the beam switching occurs responsive to measurement of poor communication link quality and cannot be predicted in advance. This reactive approach may also be seen as a cause of latency.

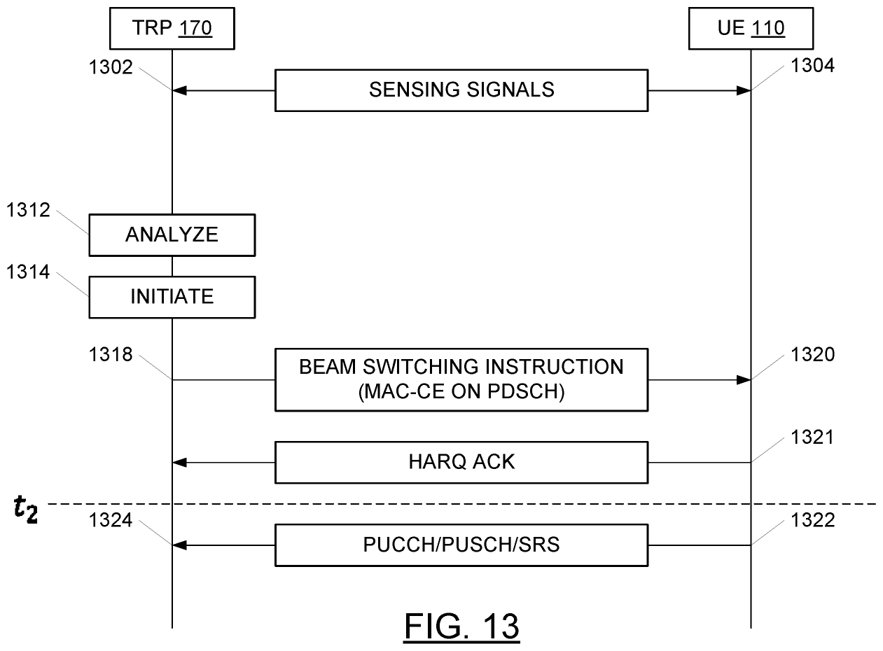

FIG. 13 illustrates, in a signal flow diagram, a beam switching procedure in accordance with aspects of the present application.

In one approach to the use of sensing signals, the TRP 170 or the UE 110 transmits (step 1302) sensing signals. The TRP 170 or the UE 110 itself then analyzes reflections of the sensing signals to obtain information about the environment in which both the TRP 170 and the UE 110 are operating.

Step 1302 and step 1304 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1312) versions of the sensed environment obtained through temporally separated transmissions (steps 1002 and/or 1004) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1312) obtaining information about the present location of the UE 110 and past locations of the UE 110, the TRP 170 may use the analyzing (step 1312) to attempt to predict a future location for the UE 110. It is in the attempt to predict a future location for the UE 110 that the TRP may employ AI technology. One result of the analyzing (step 1312) may be a future location for the UE 110. Another result of the analyzing (step 1312) may be a selection of a new transmit beam direction for use, by the UE 110, when transmitting to the TRP 170 when the UE 110 is in the future location. On the basis of trends recognized in the analyzing (step 1312), the TRP 170 may predict that the quality of the communication link between the TRP 170 and the UE 110 will deteriorate at a future moment, t₂. That is, a further result of the analyzing (step 1312) may be a prediction of the future moment, t₂, at which the new transmit beam direction is expected to provide a more robust communication link than the existing transmit beam direction.

A beam switching threshold may be pre-configured such that the TRP 170 may only initiate (step 1314) a beam switching procedure responsive to determining (step 1312) that a predicted new transmit beam direction satisfies a criteria represented by the beam switching threshold. For example, the beam switching threshold may be pre-configured to a value that is half of an angle corresponding to an m-dB beamwidth horizontal and/or n-dB beamwidth vertical. m-dB or n-dB beamwidth refers to angle between two directions where the radiated power is m dB or n dB lower than the maximum radiated power, wherein the m or n is a positive real number and the m or n is larger than 0, m can be equal to or not equal to n. Upon determining (step 1312) that the angle between the new transmit beam direction and the existing transmit beam direction exceeds the beam switching threshold, the TRP 170 may initiate (step 1314) a beam switching procedure. For example, the beam switching threshold may be pre-configured to be the metric values related to the beam quality, such as RSRP and/or SNR and/or SINR. The beam quality can be obtained by AI prediction or reference-signal-based measurement or given beams. Upon determining that the beam quality of the existing beam direction falls below the beam switching threshold, the TRP 170 may initiate a beam switching procedure. For example, the beam switching threshold may be pre-configured, which includes both of the above two thresholds, m-dB beamwidth and beam quality.

Responsive to initiating (step 1314) the beam switching procedure, the TRP 170 transmits (step 1318), to the UE 110, an instruction to perform beam switching. The transmission (step 1318) of the instruction may be accomplished using a MAC-CE on the PDSCH. The instruction may include a beam indication for the new transmit beam direction and an indication of the future time at which to switch to the new transmit beam direction for transmitting communications to the TRP 170.

The indication of the future time may take the form of a time offset (Δt). The future moment, t₂, at which the new transmit beam direction is to be employed by the UE 110 may be determined, at the UE 110, by combining the time offset, Δt, which has been received (step 1320) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. Alternatively, the reference time point, t_{ref}, may be transmitted (step 1318) as part of the beam switching instruction.

The instruction may indicate the new transmit beam direction using a coordinate-based beam indication. The instruction may indicate the new transmit beam direction as an absolute beam direction by using coordinates. Alternatively, the instruction may indicate the new transmit beam direction using a differential representation of the new transmit beam direction in the context of a reference beam direction by using differential coordinates. The reference beam direction may be related to the beam direction used, by the TRP 170, to transmit (step 1302) the sensing signals.

Notably, the new transmit beam may not be received (step 1324) at the TRP 170. Indeed, the new transmit beam may be received (step 1324) at a distinct TRP 170 defining a neighboring cell.

Typically, but not always, the TRP 170 will select (part of step 1312) the new transmit beam direction from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 1312) from among the transmit beam directions in the pre-configured transmit beam pool.

Responsive to receiving (step 1320) the beam switching instruction, the UE 110 may transmit (step 1321) an acknowledgement (e.g., a HARQ ACK) to the TRP 170 to acknowledge receipt of the switching instruction.

Subsequent to transmitting (step 1318) the beam switching instruction, the TRP 170 may wait until the specified future moment, t₂, or the specified moment at which a PUSCH or PUCCH or SRS is transmitted after the future moment, t₂, to apply the new receive beam direction to the task of communicating (step 1324) with the UE 110 using PUSCH or PUCCH or SRS.

Responsive to receiving (step 1320) the beam switching instruction, the UE 110 may wait until the specified future moment, t₂ or the specified moment at which a PUSCH or PUCCH or SRS is transmitted after the future moment, t₂ to apply the new transmit beam direction to the task of transmitting (step 1322) the communication to the TRP 170.

For PUCCH transmission, if a PUCCH transmission (step 1322) is to be performed at the future moment, t₂, the UE 110 is to apply the new transmit beam direction to the PUCCH transmission (step 1322) at the future moment, t₂. If a PUCCH transmission (step 1322) is to be performed after the future moment, t₂, the UE 110 is to apply the new transmit beam direction to the PUCCH transmission (step 1322) after the future moment, t₂.

For PUSCH transmission, if a PUSCH transmission (step 1322) is to be performed at the future moment, t₂, the UE 110 is to apply the new transmit beam direction to the PUCCH transmission (step 1322) at the future moment, t₂. If a PUSCH transmission (step 1322) is to be performed after the future moment, t₂, the UE 110 is to apply the new transmit beam direction to the PUSCH transmission (step 1322) after the future moment, t₂.

For SRS transmission in periodic and/or aperiodic and/or semi-persistent mode, if a SRS transmission (step 1322) is to be performed at the future moment, t₂, the UE 110 is to apply the new transmit beam direction to the SRS transmission (step 1322) at the future moment, t₂. If an SRS transmission (step 1322) is to be performed after the future moment, t₂, the UE 110 is to apply the new transmit beam direction to the SRS transmission (step 1322) after the future moment, t₂.

In contrast to the reactive method presented in FIG. 12, the method presented in FIG. 13 may be considered to be a proactive method. By means of prediction, the UE 110 can be notified, in advance, of a plan to perform beam switching at a specific moment, before communication quality deteriorates.

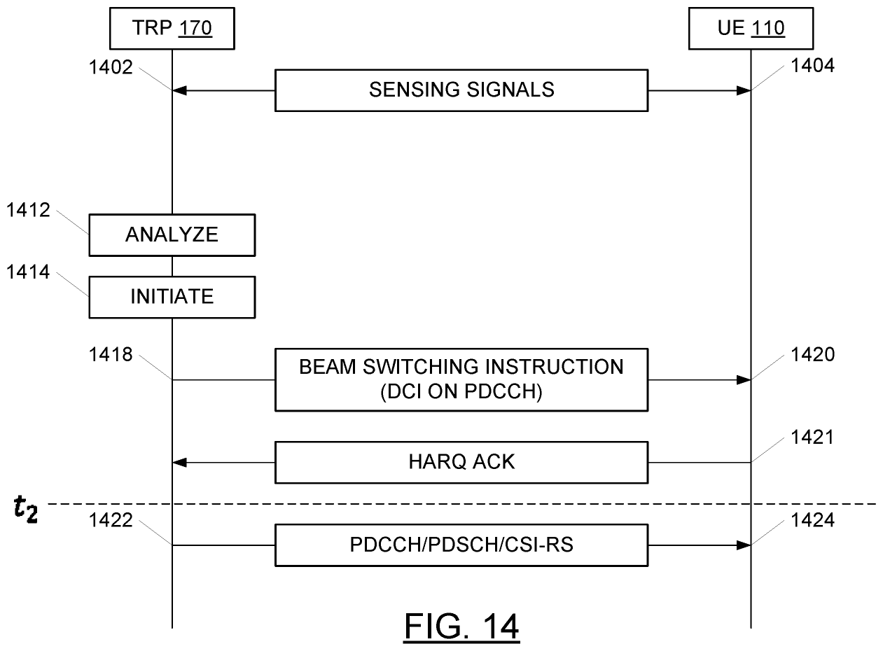

FIG. 14 illustrates, in a signal flow diagram, a beam switching procedure in accordance with aspects of the present application.

It has been discussed hereinbefore that a coordinate system may be predetermined. It has been also been discussed hereinbefore that location information and orientation information for the TRP 170 may be broadcast to all UEs 110 in communication range of the TRP 170. In particular, the location information and orientation information for the TRP 170 may be included in a SIB1. The location information and orientation information may be represented in the predetermined coordinate system.

One aspect of predicting a reason for initiating a beam switching procedure involves the TRP 170 monitoring the location of the UE 110.

Options for monitoring the location of the UE 110 may include the use of AI technology and the use of sensing signals and the use of channel measurement and the use of channel monitoring.

In one approach to the use of sensing signals, the TRP 170 or the UE 110 transmits (step 1402) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 1404) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 1402 and step 1404 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1412) versions of the sensed environment obtained through temporally separated transmissions (steps 1102 and/or 1104) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1412) obtaining information about the present location of the UE 110 and past locations of the UE 110, the TRP 170 may use the analyzing (step 1412) to attempt to predict a future location for the UE 110. It is in the attempt to predict a future location for the UE 110 that the TRP may employ AI technology. One result of the analyzing (step 1412) may be a future location for the UE 110. Another result of the analyzing (step 1412) may be a selection of a new transmit beam direction for use, by the TRP 170, when transmitting to the UE 110 when the UE 110 is in the future location. On the basis of trends recognized in the analyzing (step 1312), the TRP 170 may predict that the quality of the communication link between the TRP 170 and the UE 110 will deteriorate at a future moment, t₂. That is, a further result of the analyzing (step 1412) may be a prediction of the future moment, t₂, at which the new transmit beam direction is expected to provide a more robust communication link than the existing transmit beam direction.

Responsive to initiating (step 1414) the beam switching procedure, the TRP 170 transmits (step 1418), to the UE 110, an instruction to perform beam switching. The transmission (step 1418) of the instruction may be accomplished using a DCI on the PDCCH. The instruction may include a beam indication for a new receive beam direction corresponding to the new transmit beam direction and an indication of the future time at which the switch to the new transmit beam direction will occur at the TRP 170.

The indication of the future time may take the form of a time offset (Δt). The future moment, t₂, at which the new transmit beam direction is to be employed by the TRP 170 may be determined, at the UE 110, by combining the time offset, Δt, which has been received (step 1420) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. For example, the reference time point, t_{ref}, may be pre-configured to be the time of the transmission (step 1418) of the instruction. Alternatively, the reference time point, t_{ref}, may be transmitted (step 1418) as part of the beam switching instruction.

The instruction may indicate the new receive beam direction using a coordinate-based beam indication. The instruction may indicate the new receive beam direction as an absolute beam direction by using coordinates. Alternatively, the instruction may indicate the new receive beam direction using a differential representation of the new receive beam direction in the context of a reference beam direction by using differential coordinates. The reference beam direction may be related to the beam direction used, by the TRP 170, to transmit (step 1402) the sensing signals.

Notably, the new transmit beam may not be transmitted (step 1422) by the TRP 170. Indeed, the new transmit beam may be transmitted (step 1422) by a distinct TRP 170 defining a neighboring cell.

Typically, but not always, the TRP 170 will select (part of step 1412) the new transmit beam direction from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 1412) from among the transmit beam directions in the pre-configured transmit beam pool.

Responsive to receiving (step 1420) the beam switching instruction, the UE 110 may transmit (step 1421) an acknowledgement (e.g., a HARQ ACK) to the TRP 170 to acknowledge receipt of the switching instruction.

Subsequent to transmitting (step 1418) the beam switching instruction, the TRP 170 may wait until the specified future moment, t₂, or the specified moment at which a PDSCH or PDCCH or CSI-RS is transmitted after the future moment, t₂, to apply the new transmit beam direction to the task of communicating (step 1422) with the UE 110 using PDSCH or PDCCH or CSI-RS.

Responsive to receiving (step 1420) the beam switching instruction, the UE 110 may wait until the specified future moment, t₂, or the specified moment at which a PDSCH or PDCCH or CSI-RS is transmitted after the future moment, t₂, to apply the new receive beam direction to the task of receiving (step 1424) the communication from the TRP 170.

For PDCCH transmission, if a PDCCH transmission (step 1422) is to be performed at the future moment, t₂, the TRP 170 is to apply the new transmit beam direction to the PDCCH transmission (step 1422) at the future moment, t₂. If a PDCCH transmission (step 1422) is to be performed after the future moment, t₂, the TRP 170 is to apply the new transmit beam direction to the PDCCH transmission (step 1422) after the future moment, t₂.

For PDSCH transmission, if a PDSCH transmission (step 1422) is to be performed at the future moment, t₂, the TRP 170 is to apply the new transmit beam direction to the PDCCH transmission (step 1422) at the future moment, t₂. If a PDSCH transmission (step 1422) is to be performed after the future moment, t₂, the TRP 170 is to apply the new transmit beam direction to the PDSCH transmission (step 1422) after the future moment, t₂.

For CSI-RS transmission in periodic and/or aperiodic and/or semi-persistent mode, if a CSI-RS transmission (step 1422) is to be performed at the future moment, t₂, the TRP 170 is to apply the new transmit beam direction to the CSI-RS transmission (step 1422) at the future moment, t₂. If a CSI-RS transmission (step 1422) is to be performed after the future moment, t₂, the TRP 170 is to apply the new transmit beam direction to the CSI-RS transmission (step 1422) after the future moment, t₂.

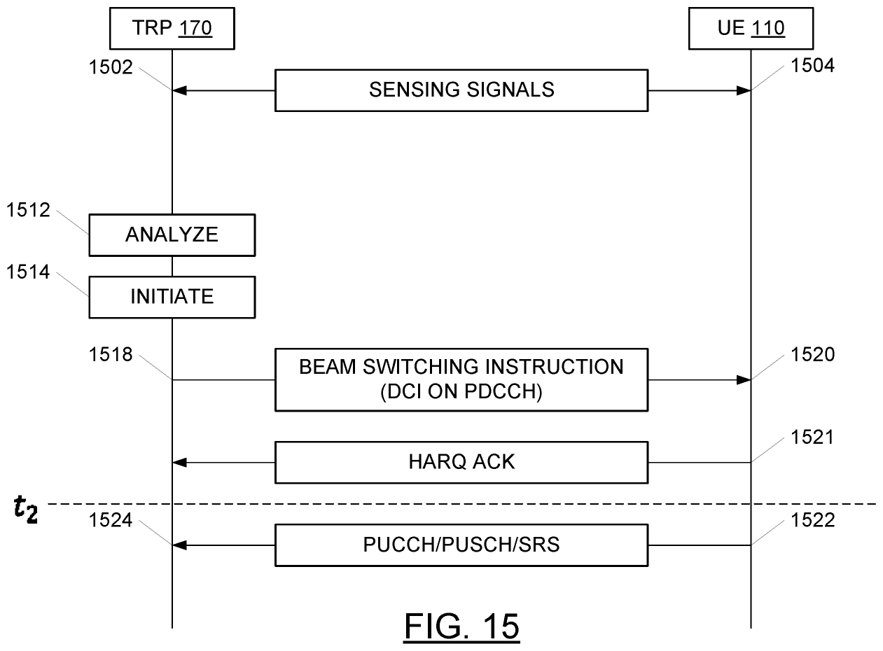

FIG. 15 illustrates, in a signal flow diagram, a beam switching procedure in accordance with aspects of the present application.

In one approach to the use of sensing signals, the TRP 170 or the UE 110 transmits (step 1502) sensing signals. The TRP 170 or the UE 110 itself then analyzes reflections of the sensing signals to obtain information about the environment in which both the TRP 170 and the UE 110 are operating.

Step 1502 and step 1504 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1512) versions of the sensed environment obtained through temporally separated transmissions (steps 1202 and/or 1204) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1512) obtaining information about the present location of the UE 110 and past locations of the UE 110, the TRP 170 may use the analyzing (step 1512) to attempt to predict a future location for the UE 110. It is in the attempt to predict a future location for the UE 110 that the TRP may employ AI technology. One result of the analyzing (step 1512) may be a future location for the UE 110. Another result of the analyzing (step 1512) may be a selection of a new transmit beam direction for use, by the UE 110, when transmitting to the TRP 170 when the UE 110 is in the future location. On the basis of trends recognized in the analyzing (step 1512), the TRP 170 may predict that the quality of the communication link between the TRP 170 and the UE 110 will deteriorate at a future moment, t₂. That is, a further result of the analyzing (step 1512) may be a prediction of the future moment, t₂, at which the new transmit beam direction is expected to provide a more robust communication link than the existing transmit beam direction.

Responsive to initiating (step 1514) the beam switching procedure, the TRP 170 transmits (step 1518), to the UE 110, an instruction to perform beam switching. The transmission (step 1518) of the instruction may be accomplished using a DCI on the PDCCH. The instruction may include a beam indication for the new transmit beam direction and an indication of the future time at which to switch to the new transmit beam direction for transmitting communications to the TRP 170.

The indication of the future time may take the form of a time offset (Δt). The future moment, t₂, at which the new transmit beam direction is to be employed by the UE 110 may be determined, at the UE 110, by combining the time offset, Δt, which has been received (step 1520) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. Alternatively, the reference time point, t_{ref}, may be transmitted (step 1518) as part of the beam switching instruction.

The instruction may indicate the new transmit beam direction using a coordinate-based beam indication. The instruction may indicate the new transmit beam direction as an absolute beam direction by using coordinates. Alternatively, the instruction may indicate the new transmit beam direction using a differential representation of the new transmit beam direction in the context of a reference beam direction by using differential coordinates. The reference beam direction may be related to the beam direction used, by the TRP 170, to transmit (step 1502) the sensing signals.

Notably, the new transmit beam may not be received (step 1524) at the TRP 170. Indeed, the new transmit beam may be received (step 1524) at a distinct TRP 170 defining a neighboring cell.

Typically, but not always, the TRP 170 will select (part of step 1512) the new transmit beam direction from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 1512) from among the transmit beam directions in the pre-configured transmit beam pool.

Responsive to receiving (step 1520) the beam switching instruction, the UE 110 may transmit (step 1521) an acknowledgement (e.g., a HARQ ACK) to the TRP 170 to acknowledge receipt of the switching instruction.

Subsequent to transmitting (step 1518) the beam switching instruction, the TRP 170 may wait until the specified future moment, t₂, or the specified moment at which a PUSCH or PUCCH or SRS is transmitted after the future moment, t₂, to apply the new receive beam direction to the task of communicating (step 1524) with the UE 110 using PUSCH or PUCCH or SRS.

Responsive to receiving (step 1520) the beam switching instruction, the UE 110 may wait until the specified future moment, t₂, or the specified moment at which a PUSCH or PUCCH or SRS is transmitted after the future moment, t₂, to apply the new transmit beam direction to the task of transmitting (step 1522) the communication to the TRP 170.

For PUCCH transmission, if a PUCCH transmission (step 1522) is to be performed at the future moment, t₂, the UE 110 is to apply the new transmit beam direction to the PUCCH transmission (step 1522) at the future moment, t₂. If a PUCCH transmission (step 1522) is to be performed after the future moment, t₂, the UE 110 is to apply the new transmit beam direction to the PUCCH transmission (step 1522) after the future moment, t₂.

For PUSCH transmission, if a PUSCH transmission (step 1522) is to be performed at the future moment, t₂, the UE 110 is to apply the new transmit beam direction to the PUCCH transmission (step 1522) at the future moment, t₂. If a PUSCH transmission (step 1522) is to be performed after the future moment, t₂, the UE 110 is to apply the new transmit beam direction to the PUSCH transmission (step 1522) after the future moment, t₂.

For SRS transmission in periodic and/or aperiodic and/or semi-persistent mode, if a SRS transmission (step 1522) is to be performed at the future moment, t₂, the UE 110 is to apply the new transmit beam direction to the SRS transmission (step 1522) at the future moment, t₂. If an SRS transmission (step 1522) is to be performed after the future moment, t₂, the UE 110 is to apply the new transmit beam direction to the SRS transmission (step 1522) after the future moment, t₂.

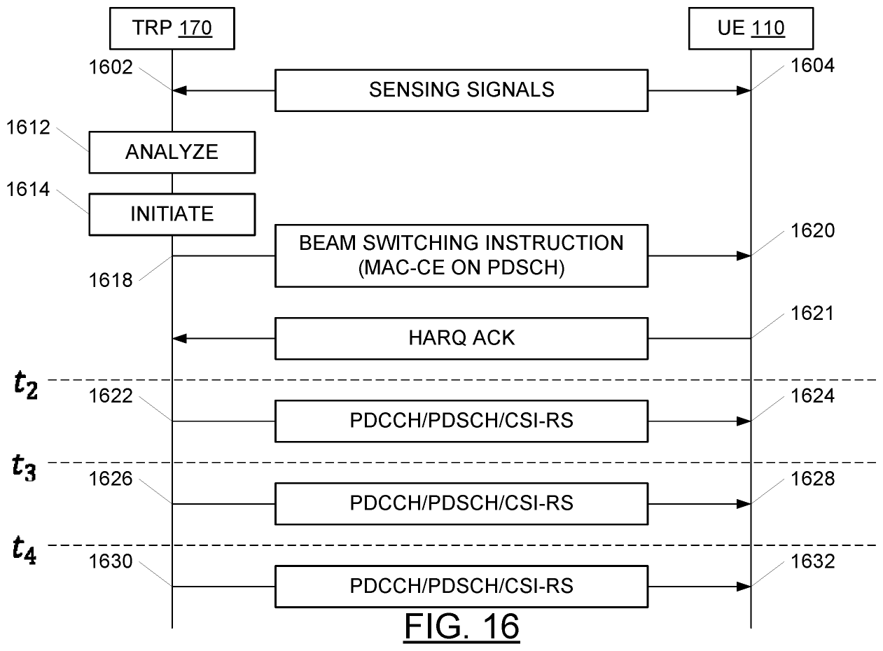

FIG. 16 illustrates, in a signal flow diagram, a beam switching procedure in accordance with aspects of the present application.

In this embodiment, one indication signaling is transmitted to indicate subsequent beam directions that changes with time in a subsequent period of time.

In one approach to the use of sensing signals, the TRP 170 or the UE 110 transmits (step 1602) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 1604) sensing signals. The another device, TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170).

Step 1602 and step 1604 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1612) versions of the sensed environment obtained through temporally separated transmissions (steps 1102 and/or 1104) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1612) obtaining information about the present location of the UE 110 and past locations of the UE 110, the TRP 170 may use the analyzing (step 1612) to attempt to predict a future location for the UE 110. It is in the attempt to predict a future location for the UE 110 that the TRP may employ AI technology. One result of the analyzing (step 1612) may be multiple future locations for the UE 110. Another result of the analyzing (step 1612) may be a selection of multiple new transmit beam directions for use, by the TRP 170, when transmitting to the UE 110 when the UE 110 is in the future locations. On the basis of trends recognized in the analyzing (step 1612), the TRP 170 may predict that the quality of the communication link between the TRP 170 and the UE 110 will deteriorate at a future moment, t₂. That is, a further result of the analyzing (step 1612) may be a prediction of the future moment, t₂, at which a first one of the new transmit beam directions is expected to provide a more robust communication link than the existing transmit beam direction.

Responsive to initiating (step 1614) the beam switching procedure, the TRP 170 transmits (step 1618), to the UE 110, an instruction to perform beam switching. The transmission (step 1618) of the instruction may be accomplished using a MAC-CE on the PDSCH.

The signal flow of FIG. 14 applies to scenarios wherein the UE 110 moves so fast that the transmit beam direction, at the TRP 170, may benefit from quickly switching in a short period of time. In the signal flow of FIG. 11, the beam switching instruction transmitted in step 1118 included a single new beam direction and a single indication of a future moment at which the single new beam direction is to be applied. In contrast, in the signal flow of FIG. 16, the beam switching instruction transmitted in step 1618 includes multiple new beam directions and multiple indications of future moments at which an individual new beam direction, among the multiple new beam directions, is to be applied in order.

Rather than include a single beam indication for a new receive beam direction corresponding to the new transmit beam direction and an indication of the future time at which the switch to the new transmit beam direction will occur at the TRP 170, the instruction may include a plurality of beam indications for new receive beam directions corresponding to the plurality of new transmit beam directions and an indication of the plurality of future times at which the switch to respective new transmit beam directions will occur at the TRP 170.

Rather than indicate a plurality of distinct receive beam directions, the instruction may include an indication of a pattern representative of a plurality of distinct receive beam directions. Furthermore, rather than indicating a plurality of future times, the instruction may include a reference to a start time and time duration of each distinct receive beam direction.

The indication of the future moment, or the start time, may take the form of a time offset (Δt). The future moment or start time, t₂, at which the first new transmit beam direction is to be employed by the TRP 170 may be determined, at the UE 110, by combining the time offset, Δt, which has been received (step 1620) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 1618) as part of the beam switching instruction.

The instruction may indicate the plurality of new receive beam directions using a coordinate-based beam indication. The instruction may indicate the new receive beam directions as absolute beam directions by using coordinates. Alternatively, the instruction may indicate the new receive beam directions using a differential representation of the new receive beam directions in the context of a reference beam direction by using differential coordinates. The reference beam direction may be related to the beam direction used, by the TRP 170, to transmit (step 1602) the sensing signals.

Notably, the new transmit beams may not be transmitted (step 1622) by the TRP 170. Indeed, the new transmit beams may be transmitted (step 1622) by a distinct TRP 170 defining a neighboring cell.

Typically, but not always, the TRP 170 will select (part of step 1612) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 1612) from among the transmit beam directions in the pre-configured transmit beam pool.

Responsive to receiving (step 1620) the beam switching instruction, the UE 110 may transmit (step 1621) an acknowledgement (e.g., a HARQ ACK) to the TRP 170 to acknowledge receipt of the switching instruction.

Subsequent to transmitting (step 1618) the beam switching instruction, the TRP 170 may wait until the specified future moment, t₂, or the specified moment at which a PDSCH or PDCCH or CSI-RS is transmitted after the future moment, t₂, to apply the new transmit beam direction to the task of communicating (step 1622) with the UE 110 using PDSCH or PDCCH or CSI-RS.

Responsive to receiving (step 1620) the beam switching instruction, the UE 110 may wait until the specified future moment, t₂, or the specified moment at which a PDSCH or PDCCH or CSI-RS is transmitted after the future moment, t₂, to apply the new receive beam direction to the task of receiving (step 1624) the communication from the TRP 170.

The TRP 170 may then wait until a next moment, t₃, or the specified moment at which a PDSCH or PDCCH or CSI-RS is transmitted after the future moment, t₃, to apply a next new transmit beam direction to the task of communicating (step 1626) with the UE 110 using PDSCH or PDCCH or CSI-RS.

The UE 110 may then wait until the next moment, t₃, or the specified moment at which a PDSCH or PDCCH or CSI-RS is transmitted after the future moment, t₃, to apply the next new receive beam direction to the task of receiving (step 1628) the communication from the TRP 170.

The TRP 170 may then wait until a further moment, t₄, or the specified moment at which a PDSCH or PDCCH or CSI-RS is transmitted after the future moment, t₄, to apply a further new transmit beam direction to the task of communicating (step 1630) with the UE 110 using PDSCH or PDCCH or CSI-RS.

The UE 110 may then wait until the further moment, t₄, or the specified moment at which a PDSCH or PDCCH or CSI-RS is transmitted after the future moment, t₄, to apply the further new receive beam direction to the task of receiving (step 1632) the communication from the TRP 170.

If a PDCCH transmission is to be performed at the future moment, t₂, the TRP 170 is to apply the new transmit beam direction to the PDCCH transmission (step 1622) at the future moment, t₂. If a PDCCH transmission is to be performed after the future moment, t₂, the TRP 170 is to determine the new transmit beam direction that is associated with the future moment and apply the determined new transmit beam direction to the PDCCH transmission after the future moment, t₂.

If a PDSCH transmission is to be performed at the future moment, t₂, the TRP 170 is to apply the new transmit beam direction to the PDCCH transmission (step 1622) at the future moment, t₂. If a PDSCH transmission (step 1622) is to be performed after the future moment, t₂, the TRP 170 is to determine the new transmit beam direction that is associated with the future moment and apply the determined new transmit beam direction to the PDSCH transmission after the future moment, t₂.

For CSI-RS transmission in periodic and/or aperiodic and/or semi-persistent mode, if a CSI-RS transmission is to be performed at the future moment, t₂, the TRP 170 is to apply the new transmit beam direction to the CSI-RS transmission (step 1622) at the future moment, t₂. If a CSI-RS transmission (step 1622) is to be performed after the future moment, t₂, the TRP 170 is to determine the new transmit beam direction that is associated with the future moment and apply the determined new transmit beam direction to the CSI-RS transmission after the future moment, t₂.

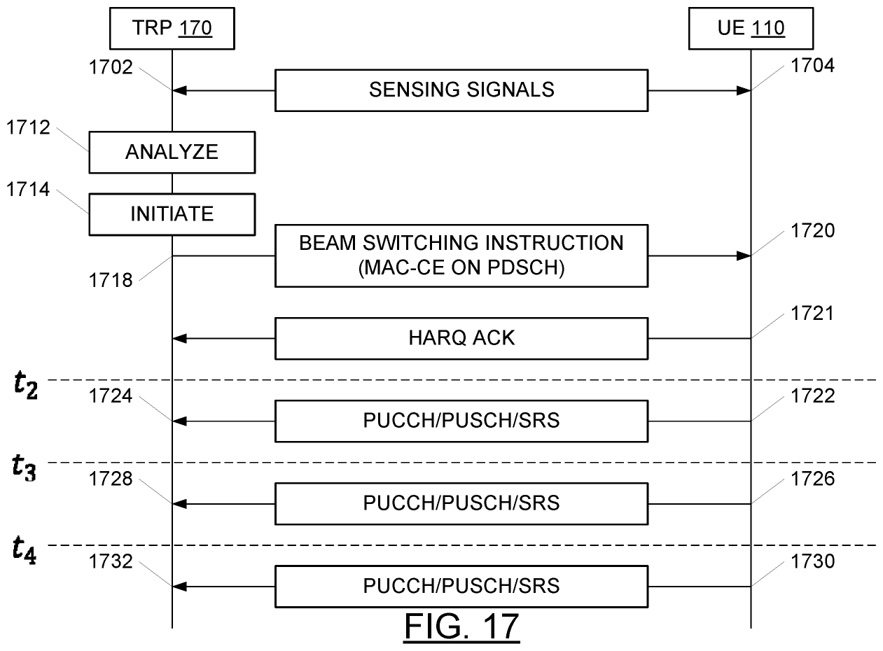

FIG. 17 illustrates, in a signal flow diagram, a beam switching procedure in accordance with aspects of the present application.

In this embodiment, one indication signaling is transmitted to indicate subsequent beam directions that change with time in a subsequent period of time.

In one approach to the use of sensing signals, the TRP 170 or the UE 110 transmits (step 1702) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 1704) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 1702 and step 1704 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1712) versions of the sensed environment obtained through temporally separated transmissions (steps 1402 and/or 1404) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1712) obtaining information about the present location of the UE 110 and past locations of the UE 110, the TRP 170 may use the analyzing (step 1712) to attempt to predict a future location for the UE 110. It is in the attempt to predict a future location for the UE 110 that the TRP may employ AI technology. One result of the analyzing (step 1712) may be multiple future locations for the UE 110. Another result of the analyzing (step 1712) may be a selection of multiple new transmit beam directions for use, by the TRP 170, when transmitting to the UE 110 when the UE 110 is in the future locations. On the basis of trends recognized in the analyzing (step 1712), the TRP 170 may predict that the quality of the communication link between the TRP 170 and the UE 110 will deteriorate at a future moment, t₂. That is, a further result of the analyzing (step 1712) may be a prediction of the future moment, t₂, at which a first one of the new transmit beam directions is expected to provide a more robust communication link than the existing transmit beam direction.

Responsive to initiating (step 1714) the beam switching procedure, the TRP 170 transmits (step 1718), to the UE 110, an instruction to perform beam switching. The transmission (step 1718) of the instruction may be accomplished using a MAC-CE on the PDSCH.

The signal flow of FIG. 17 applies to scenarios wherein the UE 110 moves so fast that the transmit beam direction, at the UE 110, may benefit from quickly switching in a short period of time. In the signal flow of FIG. 13, the transmit beam switching instruction transmitted in step 1318 included a single new transmit beam direction and a single indication of a future moment at which the single new transmit beam direction is to be applied. In contrast, in the signal flow of FIG. 17, the transmit beam switching instruction transmitted in step 1718 includes multiple new transmit beam directions and multiple indications of future moments at which an individual new transmit beam direction, among the multiple new transmit beam directions, is to be applied in order.

Rather than include a single beam indication for a new transmit beam and an indication of the future time at which the switch to the new transmit beam direction is to occur at the UE 110, the instruction may include a plurality of beam indications for new transmit beam directions and an indication of the plurality of future times at which the switch to respective new transmit beam directions are to occur at the UE 110.

Rather than indicate a plurality of distinct transmit beam directions, the instruction may include an indication of a pattern representative of a plurality of distinct transmit beam directions. Furthermore, rather than indicating a plurality of future times, the instruction may include a reference to a start time and time duration of each distinct transmit beam direction.

The indication of the future moment, or the start time, may take the form of a time offset (Δt). The future moment or start time, t₂, at which the first new transmit beam direction is to be employed by the UE 110 may be determined, at the UE 110, by combining the time offset, Δt, which has been received (step 1720) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 1718) as part of the beam switching instruction.

The instruction may indicate the plurality of new transmit beam directions using a coordinate-based beam indication. The instruction may indicate the new transmit beam directions as absolute beam directions by using coordinates. Alternatively, the instruction may indicate the new transmit beam directions using a differential representation of the new transmit beam directions in the context of a reference beam direction by using differential coordinates. The reference beam direction may be related to the beam direction used, by the TRP 170, to transmit (step 1702) the sensing signals.

Notably, the new transmit beams may not be received (step 1724) by the TRP 170. Indeed, the new transmit beams may be received (step 1724) by a distinct TRP 170 defining a neighboring cell.

Typically, but not always, the TRP 170 will select (part of step 1712) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 1712) from among the transmit beam directions in the pre-configured transmit beam pool.

Responsive to receiving (step 1720) the beam switching instruction, the UE 110 may transmit (step 1721) an acknowledgement (e.g., a HARQ ACK) to the TRP 170 to acknowledge receipt of the switching instruction.

Subsequent to receiving (step 1720) the beam switching instruction, the UE 110 may wait until the specified future moment, t₂, or the specified moment at which a PUSCH or PUCCH or SRS. is transmitted after the future moment, t₂, to apply the new transmit beam direction to the task of communicating (step 1722) with the TRP 170 using PUSCH or PUCCH or SRS.

Responsive to transmitting (step 1718) the beam switching instruction, the TRP 170 may wait until the specified future moment, t₂, or the specified moment at which a PUSCH or PUCCH or SRS is transmitted after the future moment, t₂, to apply the new receive beam direction to the task of receiving (step 1724) the communication from the UE 110.

The UE 110 may then wait until a next moment, t₃, or the specified moment at which a PUSCH or PUCCH or SRS is transmitted after the future moment, t₃, to apply a next new transmit beam direction to the task of communicating (step 1726) with the TRP 170 using PUSCH or PUCCH or SRS.

The TRP 170 may then wait until the next moment, t₃, or the specified moment at which a PUSCH or PUCCH or SRS is transmitted after the future moment, t₃, to apply the next new receive beam direction to the task of receiving (step 1728) the communication from the UE 110.

The UE 110 may then wait until a further moment, t₄, or the specified moment at which a PUSCH or PUCCH or SRS is transmitted after the future moment, t₄, to apply a further new transmit beam direction to the task of communicating (step 1730) with the TRP 170 using PUSCH or PUCCH or SRS.

The TRP 170 may then wait until the further moment, t₄, or the specified moment at which a PUSCH or PUCCH or SRS is transmitted after the future moment, t₄, to apply the further new receive beam direction to the task of receiving (step 1732) the communication from the UE 110.

If a PUCCH transmission is to be performed at the future moment, t₂, the UE 110 is to apply the new transmit beam direction to the PUCCH transmission (step 1722) at the future moment, t₂. If a PUCCH transmission is to be performed after the future moment, t₂, the UE 110 is to determine the new transmit beam direction that is associated with the future moment and apply the determined new transmit beam direction to the PUCCH transmission after the future moment, t₂.

If a PUSCH transmission is to be performed at the future moment, t₂, the UE 110 is to apply the new transmit beam direction to the PUCCH transmission (step 1722) at the future moment, t₂. If a PUSCH transmission (step 1722) is to be performed after the future moment, t₂, the TRP 170 is to determine the new transmit beam direction that is associated with the future moment and apply the determined new transmit beam direction to the PUSCH transmission after the future moment, t₂.

For SRS transmission in periodic and/or aperiodic and/or semi-persistent mode, if a SRS transmission is to be performed at the future moment, t₂, the UE 110 is to apply the new transmit beam direction to the SRS transmission (step 1722) at the future moment, t₂. If a SRS transmission (step 1722) is to be performed after the future moment, t₂, the UE 110 is to determine the new transmit beam direction that is associated with the future moment and apply the determined new transmit beam direction to the SRS transmission after the future moment, t₂.

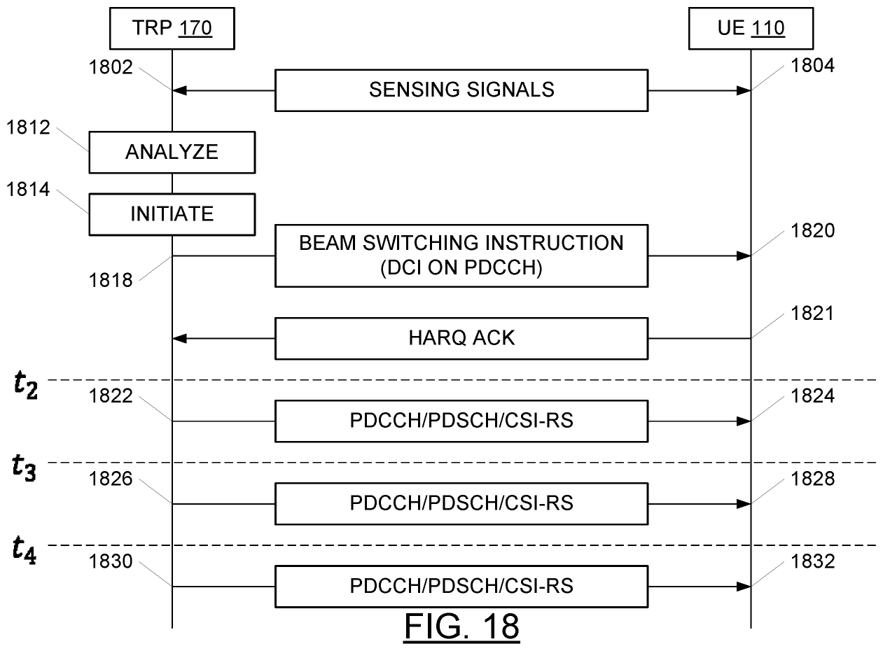

FIG. 18 illustrates, in a signal flow diagram, a beam switching procedure in accordance with aspects of the present application.

In this embodiment, one indication signaling is transmitted to indicate subsequent beam directions that changes with time in a subsequent period of time.

In one approach to the use of sensing signals, the TRP 170 or the UE 110 transmits (step 1802) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 1804) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 1802 and step 1804 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1812) versions of the sensed environment obtained through temporally separated transmissions (steps 1502 and/or 1504) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1812) obtaining information about the present location of the UE 110 and past locations of the UE 110, the TRP 170 may use the analyzing (step 1812) to attempt to predict a future location for the UE 110. It is in the attempt to predict a future location for the UE 110 that the TRP may employ AI technology. One result of the analyzing (step 1812) may be multiple future locations for the UE 110. Another result of the analyzing (step 1812) may be a selection of multiple new transmit beam directions for use, by the TRP 170, when transmitting to the UE 110 when the UE 110 is in the future locations. On the basis of trends recognized in the analyzing (step 1812), the TRP 170 may predict that the quality of the communication link between the TRP 170 and the UE 110 will deteriorate at a future moment, t₂. That is, a further result of the analyzing (step 1812) may be a prediction of the future moment, t₂, at which a first one of the new transmit beam directions is expected to provide a more robust communication link than the existing transmit beam direction.

Responsive to initiating (step 1814) the beam switching procedure, the TRP 170 transmits (step 1818), to the UE 110, an instruction to perform beam switching. The transmission (step 1818) of the instruction may be accomplished using a DCI on the PDCCH.

The signal flow of FIG. 18 applies to scenarios wherein the UE 110 moves so fast that the transmit beam direction, at the TRP 170, may benefit from quickly switching in a short period of time. In the signal flow of FIG. 11, the beam switching instruction transmitted in step 1118 included a single new beam direction and a single indication of a future moment at which the single new beam direction is to be applied. In contrast, in the signal flow of FIG. 18, the beam switching instruction transmitted in step 1818 includes multiple new beam directions and multiple indications of future moments at which an individual new beam direction, among the multiple new beam directions, is to be applied.

Rather than include a single beam indication for a new receive beam direction corresponding to the new transmit beam direction and an indication of the future time at which the switch to the new transmit beam direction will occur at the TRP 170, the instruction may include a plurality of beam indications for new receive beam directions corresponding to the plurality of new transmit beam directions and an indication of the plurality of future times at which the switch to respective new transmit beam directions will occur at the TRP 170.

Rather than indicate a plurality of distinct receive beam directions, the instruction may include an indication of a pattern representative of a plurality of distinct receive beam directions. Furthermore, rather than indicating a plurality of future times, the instruction may include a reference to a start time and time duration of each distinct receive beam direction.

The indication of the future moment, or the start time, may take the form of a time offset (Δt). The future moment or start time, t₂, at which the first new transmit beam direction is to be employed by the TRP 170 may be determined, at the UE 110, by combining the time offset, Δt, which has been received (step 1820) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 1818) as part of the beam switching instruction.

The instruction may indicate the plurality of new receive beam directions using a coordinate-based beam indication. The instruction may indicate the new receive beam directions as absolute beam directions by using coordinates. Alternatively, the instruction may indicate the new receive beam directions using a differential representation of the new receive beam directions in the context of a reference beam direction by using differential coordinates. The reference beam direction may be related to the beam direction used, by the TRP 170, to transmit (step 1802) the sensing signals.

Notably, the new transmit beams may not be transmitted (step 1822) by the TRP 170. Indeed, the new transmit beams may be transmitted (step 1822) by a distinct TRP 170 defining a neighboring cell.

Typically, but not always, the TRP 170 will select (part of step 1812) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 1812) from among the transmit beam directions in the pre-configured transmit beam pool.

Responsive to receiving (step 1820) the beam switching instruction, the UE 110 may transmit (step 1821) an acknowledgement (e.g., a HARQ ACK) to the TRP 170 to acknowledge receipt of the switching instruction.

Subsequent to transmitting (step 1818) the beam switching instruction, the TRP 170 may wait until the specified future moment, t₂, or the specified moment at which a PDSCH or PDCCH or CSI-RS is transmitted after the future moment, t₂, to apply the new transmit beam direction to the task of communicating (step 1822) with the UE 110 using PDSCH or PDCCH or CSI-RS.

Responsive to receiving (step 1820) the beam switching instruction, the UE 110 may wait until the specified future moment, t₂, or the specified moment at which a PDSCH or PDCCH or CSI-RS is transmitted after the future moment, t₂, to apply the new receive beam direction to the task of receiving (step 1824) the communication from the TRP 170.

The TRP 170 may then wait until a next moment, t₃, or the specified moment at which a PDSCH or PDCCH or CSI-RS is transmitted after the future moment, t₃, to apply a next new transmit beam direction to the task of communicating (step 1826) with the UE 110 using PDSCH or PDCCH or CSI-RS.

The UE 110 may then wait until the next moment, t₃, or the specified moment at which a PDSCH or PDCCH or CSI-RS is transmitted after the future moment, t₃, to apply the next new receive beam direction to the task of receiving (step 1828) the communication from the TRP 170.

The TRP 170 may then wait until a further moment, t₄, or the specified moment at which a PDSCH or PDCCH or CSI-RS is transmitted after the future moment, t₄, to apply a further new transmit beam direction to the task of communicating (step 1830) with the UE 110 using PDSCH or PDCCH or CSI-RS.

The UE 110 may then wait until the further moment, t₄, or the specified moment at which a PDSCH or PDCCH or CSI-RS is transmitted after the future moment, t₄, to apply the further new receive beam direction to the task of receiving (step 1832) the communication from the TRP 170.

If a PDCCH transmission is to be performed at the future moment, t₂, the TRP 170 is to apply the new transmit beam direction to the PDCCH transmission (step 1822) at the future moment, t₂. If a PDCCH transmission is to be performed after the future moment, t₂, the TRP 170 is to determine the new transmit beam direction that is associated with the future moment and apply the determined new transmit beam direction to the PDCCH transmission after the future moment, t₂.

If a PDSCH transmission is to be performed at the future moment, t₂, the TRP 170 is to apply the new transmit beam direction to the PDCCH transmission (step 1822) at the future moment, t₂. If a PDSCH transmission (step 1822) is to be performed after the future moment, t₂, the TRP 170 is to determine the new transmit beam direction that is associated with the future moment and apply the determined new transmit beam direction to the PDSCH transmission after the future moment, t₂.

For CSI-RS transmission in periodic and/or aperiodic and/or semi-persistent mode, if a CSI-RS transmission is to be performed at the future moment, t₂, the TRP 170 is to apply the new transmit beam direction to the CSI-RS transmission (step 1822) at the future moment, t₂. If a CSI-RS transmission (step 1822) is to be performed after the future moment, t₂, the TRP 170 is to determine the new transmit beam direction that is associated with the future moment and apply the determined new transmit beam direction to the CSI-RS transmission after the future moment, t₂.

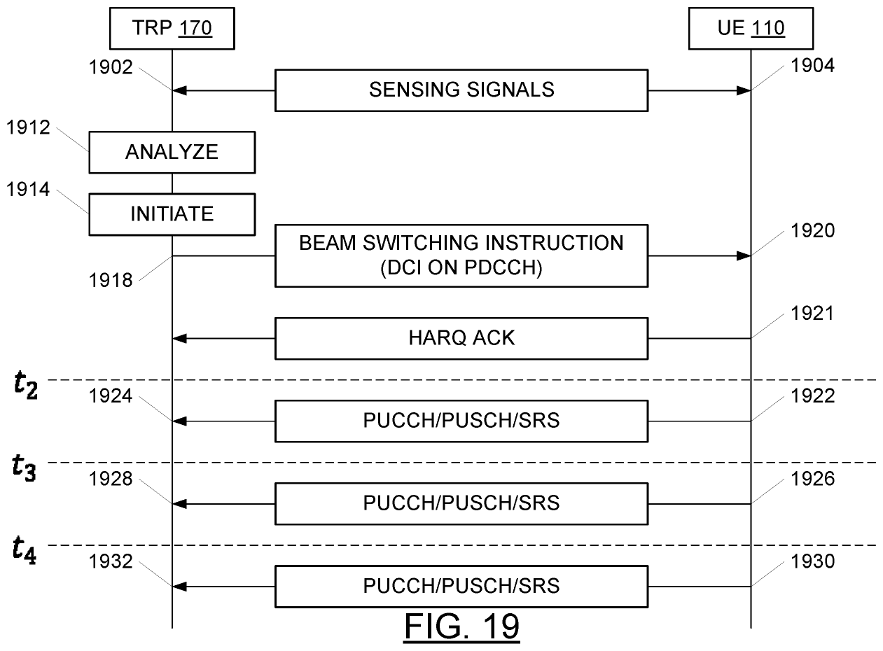

FIG. 19 illustrates, in a signal flow diagram, a beam switching procedure in accordance with aspects of the present application.

In this embodiment, one indication signaling is transmitted to indicate subsequent beam directions that change with time in a subsequent period of time.

In one approach to the use of sensing signals, the TRP 170 or the UE 110 transmits (step 1902) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 1904) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the UE 170) and the analysis of the reflections of the sensing signals takes place at another device (the TRP 170 or the UE 110).

Step 1902 and step 1904 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 1912) versions of the sensed environment obtained through temporally separated transmissions (steps 1602 and/or 1604) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 1912) obtaining information about the present location of the UE 110 and past locations of the UE 110, the TRP 170 may use the analyzing (step 1912) to attempt to predict a future location for the UE 110. It is in the attempt to predict a future location for the UE 110 that the TRP may employ AI technology. One result of the analyzing (step 1912) may be multiple future locations for the UE 110. Another result of the analyzing (step 1912) may be a selection of multiple new transmit beam directions for use, by the TRP 170, when transmitting to the UE 110 when the UE 110 is in the future locations. On the basis of trends recognized in the analyzing (step 1912), the TRP 170 may predict that the quality of the communication link between the TRP 170 and the UE 110 will deteriorate at a future moment, t₂. That is, a further result of the analyzing (step 1912) may be a prediction of the future moment, t₂, at which a first one of the new transmit beam directions is expected to provide a more robust communication link than the existing transmit beam direction.

Responsive to initiating (step 1914) the beam switching procedure, the TRP 170 transmits (step 1918), to the UE 110, an instruction to perform beam switching. The transmission (step 1918) of the instruction may be accomplished using a DCI on the PDCCH.

The signal flow of FIG. 19 applies to scenarios wherein the UE 110 moves so fast that the transmit beam direction, at the UE 110, may benefit from quickly switching in a short period of time. In the signal flow of FIG. 13, the transmit beam switching instruction transmitted in step 1318 included a single new transmit beam direction and a single indication of a future moment at which the single new transmit beam direction is to be applied. In contrast, in the signal flow of FIG. 19, the transmit beam switching instruction transmitted in step 1918 includes multiple new transmit beam directions and multiple indications of future moments at which an individual new transmit beam direction, among the multiple new transmit beam directions, is to be applied.

Rather than include a single beam indication for a new transmit beam and an indication of the future time at which the switch to the new transmit beam direction is to occur at the UE 110, the instruction may include a plurality of beam indications for new transmit beam directions and an indication of the plurality of future times at which the switch to respective new transmit beam directions are to occur at the UE 110.

Rather than indicate a plurality of distinct transmit beam directions, the instruction may include an indication of a pattern representative of a plurality of distinct transmit beam directions. Furthermore, rather than indicating a plurality of future times, the instruction may include a reference to a start time and time duration of each distinct transmit beam direction.

The indication of the future moment, or the start time, may take the form of a time offset (Δt). The future moment or start time, t₂, at which the first new transmit beam direction is to be employed by the UE 110 may be determined, at the UE 110, by combining the time offset, Δt, which has been received (step 1920) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 1918) as part of the beam switching instruction.

The instruction may indicate the plurality of new transmit beam directions using a coordinate-based beam indication. The instruction may indicate the new transmit beam directions as absolute beam directions by using coordinates. Alternatively, the instruction may indicate the new transmit beam directions using a differential representation of the new transmit beam directions in the context of a reference beam direction by using differential coordinates. The reference beam direction may be related to the beam direction used, by the TRP 170, to transmit (step 1902) the sensing signals.

Notably, the new transmit beams may not be received (step 1924) by the TRP 170. Indeed, the new transmit beams may be received (step 1924) by a distinct TRP 170 defining a neighboring cell.

Typically, but not always, the TRP 170 will select (part of step 1912) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 1912) from among the transmit beam directions in the pre-configured transmit beam pool.

Responsive to receiving (step 1920) the beam switching instruction, the UE 110 may transmit (step 1921) an acknowledgement (e.g., a HARQ ACK) to the TRP 170 to acknowledge receipt of the switching instruction.

Subsequent to receiving (step 1920) the beam switching instruction, the UE 110 may wait until the specified future moment, t₂, or the specified moment at which a PUSCH or PUCCH or SRS is transmitted after the future moment, t₂, to apply the new transmit beam direction to the task of communicating (step 1922) with the TRP 170 using PUSCH or PUCCH or SRS.

Responsive to transmitting (step 1918) the beam switching instruction, the TRP 170 may wait until the specified future moment, t₂, or the specified moment at which a PUSCH or PUCCH or SRS is transmitted after the future moment, t₂, to apply the new receive beam direction to the task of receiving (step 1924) the communication from the UE 110.

The UE 110 may then wait until a next moment, t₃, or the specified moment at which a PUSCH or PUCCH or SRS is transmitted after the future moment, t₃, to apply a next new transmit beam direction to the task of communicating (step 1926) with the TRP 170 using PUSCH or PUCCH or SRS.

The TRP 170 may then wait until the next moment, t₃, or the specified moment at which a PUSCH or PUCCH or SRS is transmitted after the future moment, t₃, to apply the next new receive beam direction to the task of receiving (step 1928) the communication from the UE 110.

The UE 110 may then wait until a further moment, t₄, or the specified moment at which a PUSCH or PUCCH or SRS is transmitted after the future moment, t₄, to apply a further new transmit beam direction to the task of communicating (step 1930) with the TRP 170 using PUSCH or PUCCH or SRS.

The TRP 170 may then wait until the further moment, t₄, or the specified moment at which a PUSCH or PUCCH or SRS is transmitted after the future moment, t₄, to apply the further new receive beam direction to the task of receiving (step 1932) the communication from the UE 110.

If a PUCCH transmission is to be performed at the future moment, t₂, the UE 110 is to apply the new transmit beam direction to the PUCCH transmission (step 1922) at the future moment, t₂. If a PUCCH transmission is to be performed after the future moment, t₂, the UE 110 is to determine the new transmit beam direction that is associated with the future moment and apply the determined new transmit beam direction to the PUCCH transmission after the future moment, t₂.

If a PUSCH transmission is to be performed at the future moment, t₂, the UE 110 is to apply the new transmit beam direction to the PUCCH transmission (step 1922) at the future moment, t₂. If a PUSCH transmission (step 1922) is to be performed after the future moment, t₂, the TRP 170 is to determine the new transmit beam direction that is associated with the future moment and apply the determined new transmit beam direction to the PUSCH transmission after the future moment, t₂.

For SRS transmission in periodic and/or aperiodic and/or semi-persistent mode, if a SRS transmission is to be performed at the future moment, t₂, the UE 110 is to apply the new transmit beam direction to the SRS transmission (step 1922) at the future moment, t₂. If a SRS transmission (step 1922) is to be performed after the future moment, t₂, the UE 110 is to determine the new transmit beam direction that is associated with the future moment and apply the determined new transmit beam direction to the SRS transmission after the future moment, t₂.

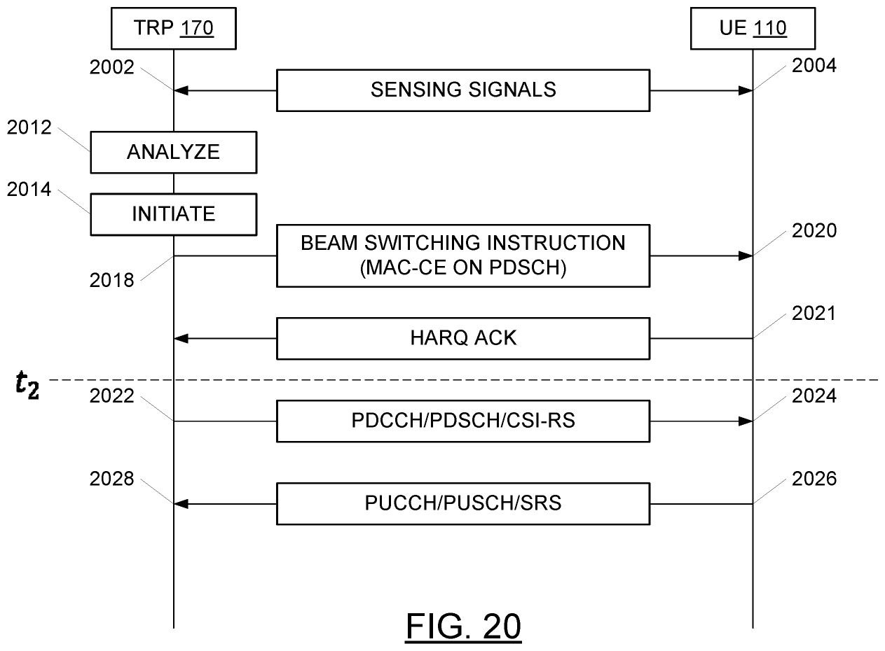

FIG. 20 illustrates, in a signal flow diagram, a beam switching procedure in accordance with aspects of the present application.

In this embodiment, one indication signaling is transmitted to simultaneously indicate multiple uplink and/or downlink channels/signals.

It has been discussed hereinbefore that a coordinate system may be predetermined. It has been also been discussed hereinbefore that location information and orientation information for the TRP 170 may be broadcast to all UEs 110 in communication range of the TRP 170. In particular, the location information and orientation information for the TRP 170 may be included in a SIBx or configured in RRC signaling. The location information and orientation information may be represented in the predetermined coordinate system.

One aspect of predicting a reason for initiating a beam switching procedure involves the TRP 170 monitoring the location of the UE 110.

Options for monitoring the location of the UE 110 may include the use of AI technology and the use of sensing signals.

In one approach to the use of sensing signals, the TRP 170 or the UE 110 transmits (step 2002) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 2004) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 2002 and step 2004 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 2012) versions of the sensed environment obtained through temporally separated transmissions (steps 1702 and/or 1704) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 2012) obtaining information about the present location of the UE 110 and past locations of the UE 110, the TRP 170 may use the analyzing (step 2012) to attempt to predict a future location for the UE 110. It is in the attempt to predict a future location for the UE 110 that the TRP may employ AI technology. One result of the analyzing (step 2012) may be a future location for the UE 110. Another result of the analyzing (step 2012) may be a selection of a new transmit beam direction for use, by the TRP 170, when transmitting to the UE 110 when the UE 110 is in the future location. A further result of the analyzing (step 2012) may be a selection of a new transmit beam direction for use, by the UE 110, when transmitting to the TRP 170 when the UE 110 is in the future location. On the basis of trends recognized in the analyzing (step 2012), the TRP 170 may predict that the quality of the communication link between the TRP 170 and the UE 110 will deteriorate at a future moment, t₂. That is, a further result of the analyzing (step 2012) may be a prediction of the future moment, t₂, at which the new transmit beam direction is expected to provide a more robust communication link than the existing transmit beam direction.

Responsive to initiating (step 2014) the beam switching procedure, the TRP 170 transmits (step 2018), to the UE 110, an instruction to perform beam switching. The transmission (step 2018) of the instruction may be accomplished using a MAC-CE on the PDSCH. The instruction may include a beam indication for a new receive beam direction for the UE 110 corresponding to the new transmit beam direction for the TRP 170 and an indication of the future time at which the switch to the new transmit beam direction will occur at the TRP 170. The instruction may also include a beam indication for the new transmit beam direction for the UE 110.

The indication of the future time may take the form of a time offset (Δt). The future moment, t₂, at which the new transmit beam directions are to be employed by the TRP 170 and the UE 110 may be determined, at the UE 110, by combining the time offset, Δt, which has been received (step 2020) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. Alternatively, the reference time point, t_{ref}, may be transmitted (step 2018) as part of the beam switching instruction.

The instruction may indicate the new beam directions using a coordinate-based beam indication. The instruction may indicate the new receive beam directions as absolute beam directions by using coordinates. Alternatively, the instruction may indicate the new receive beam directions using differential representation of the new receive beam directions in the context of a reference beam direction by using differential coordinates. The reference beam direction may be related to the beam direction used, by the TRP 170, to transmit (step 2002) the sensing signals.

Notably, the new transmit beam may not be transmitted (step 2022) by the TRP 170. Indeed, the new transmit beam may be transmitted (step 2022) by a distinct TRP 170 defining a neighboring cell.

Typically, but not always, the TRP 170 will select (part of step 2012) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 2012) from among the transmit beam directions in the pre-configured transmit beam pool.

Responsive to receiving (step 2020) the beam switching instruction, the UE 110 may transmit (step 2021) an acknowledgement (e.g., a HARQ ACK) to the TRP 170 to acknowledge receipt of the switching instruction.

Subsequent to transmitting (step 2018) the beam switching instruction, the TRP 170 may wait until the specified future moment, t₂, or the specified moment at which PDSCH and/or PDCCH and/or CSI-RS is/are transmitted after the future moment, t₂, to apply the new transmit beam direction to the task of communicating (step 2022) with the UE 110 using PDSCH and/or PDCCH and/or CSI-RS.

Responsive to receiving (step 2020) the beam switching instruction, the UE 110 may wait until the specified future moment, t₂, or the specified moment at which PDSCH and/or PDCCH and/or CSI-RS is/are transmitted after the future moment, t₂, to apply the new receive beam direction to the task of receiving (step 2024) the communication from the TRP 170.

Similarly, the TRP 170 may wait until the specified future moment, t₂, or the specified moment at which PUSCH and/or PUCCH and/or SRS is/are transmitted after the future moment, t₂, to apply the new receive beam direction to the task of communicating (step 2028) with the UE 110 using PUSCH and/or PUCCH and/or SRS.

Additionally, the UE 110 may wait until the specified future moment, t₂, or the specified moment at which PUSCH and/or PUCCH and/or SRS is/are transmitted after the future moment, t₂, to apply the new transmit beam direction to the task of transmitting (step 2026) the communication to the TRP 170.

For PDCCH transmission, if a PDCCH transmission (step 2022) is to be performed at the future moment, t₂, the TRP 170 is to apply the new transmit beam direction to the PDCCH transmission (step 2022) at the future moment, t₂. If a PDCCH transmission (step 2022) is to be performed after the future moment, t₂, the TRP 170 is to apply the new transmit beam direction to the PDCCH transmission (step 2022) after the future moment, t₂.

For PUCCH transmission, if a PUCCH transmission (step 2026) is to be performed at the future moment, t₂, the UE 110 is to apply the new transmit beam direction to the PUCCH transmission (step 2026) at the future moment, t₂. If a PUCCH transmission (step 2026) is to be performed after the future moment, t₂, the UE 110 is to apply the new transmit beam direction to the PUCCH transmission (step 2026) after the future moment, t₂.

For PDSCH transmission, if a PDSCH transmission (step 2022) is to be performed at the future moment, t₂, the TRP 170 is to apply the new transmit beam direction to the PDCCH transmission (step 2022) at the future moment, t₂. If a PDSCH transmission (step 2022) is to be performed after the future moment, t₂, the TRP 170 is to apply the new transmit beam direction to the PDSCH transmission (step 2022) after the future moment, t₂.

For PUSCH transmission, if a PUSCH transmission (step 2026) is to be performed at the future moment, t₂, the UE 110 is to apply the new transmit beam direction to the PUCCH transmission (step 2026) at the future moment, t₂. If a PUSCH transmission (step 2026) is to be performed after the future moment, t₂, the UE 110 is to apply the new transmit beam direction to the PUSCH transmission (step 2026) after the future moment, t₂.

For CSI-RS transmission in periodic and/or aperiodic and/or semi-persistent mode, if a CSI-RS transmission (step 2022) is to be performed at the future moment, t₂, the TRP 170 is to apply the new transmit beam direction to the CSI-RS transmission (step 2022) at the future moment, t₂. If a CSI-RS transmission (step 2022) is to be performed after the future moment, t₂, the TRP 170 is to apply the new transmit beam direction to the CSI-RS transmission (step 2022) after the future moment, t₂.

For SRS transmission in periodic and/or aperiodic and/or semi-persistent mode, if a SRS transmission (step 2026) is to be performed at the future moment, t₂, the UE 110 is to apply the new transmit beam direction to the SRS transmission (step 2026) at the future moment, t₂. If an SRS transmission (step 2026) is to be performed after the future moment, t₂, the UE 110 is to apply the new transmit beam direction to the SRS transmission (step 2026) after the future moment, t₂.

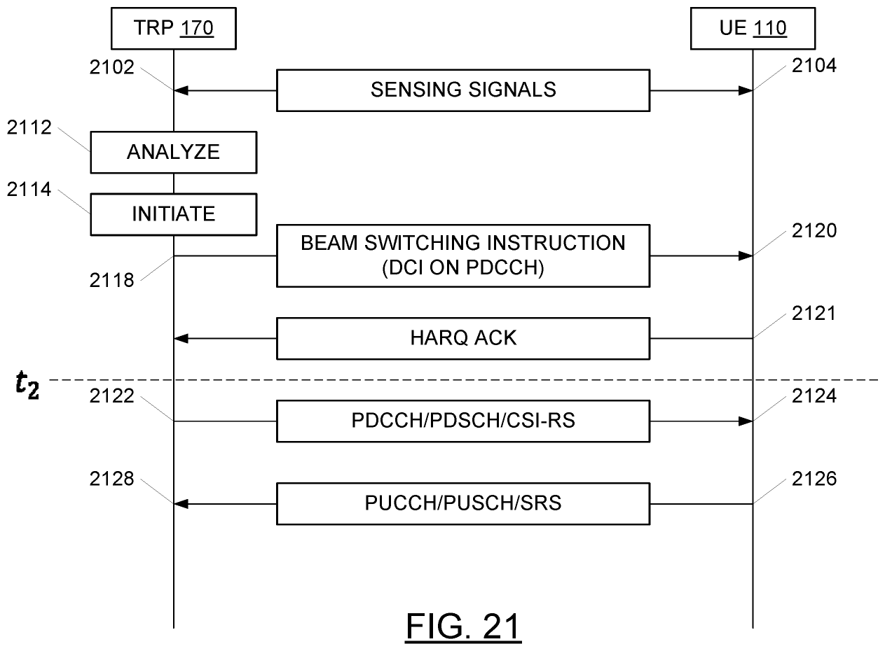

FIG. 21 illustrates, in a signal flow diagram, a beam switching procedure in accordance with aspects of the present application.

In this embodiment, one indication signaling is transmitted to simultaneously indicate multiple uplink and/or downlink channels/signals.

It has been discussed hereinbefore that a coordinate system may be predetermined. It has been also been discussed hereinbefore that location information and orientation information for the TRP 170 may be broadcast to all UEs 110 in communication range of the TRP 170. In particular, the location information and orientation information for the TRP 170 may be included in a SIBx or configured in RRC signaling. The location information and orientation information may be represented in the predetermined coordinate system.

One aspect of predicting a reason for initiating a beam switching procedure involves the TRP 170 monitoring the location of the UE 110.

Options for monitoring the location of the UE 110 may include the use of AI technology and the use of sensing signals and the use of channel measurement and the use of channel monitoring.

In one approach to the use of sensing signals, the TRP 170 or the UE 110 transmits (step 2102) sensing signals. The TRP 170 or the UE 110 itself then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 2104) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 2102 and step 2104 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 2112) versions of the sensed environment obtained through temporally separated transmissions (steps 1802 and/or 1804) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 2112) obtaining information about the present location of the UE 110 and past locations of the UE 110, the TRP 170 may use the analyzing (step 2112) to attempt to predict a future location for the UE 110. It is in the attempt to predict a future location for the UE 110 that the TRP may employ AI technology. One result of the analyzing (step 2112) may be a future location for the UE 110. Another result of the analyzing (step 2112) may be a selection of a new transmit beam direction for use, by the TRP 170, when transmitting to the UE 110 when the UE 110 is in the future location. A further result of the analyzing (step 2112) may be a selection of a new transmit beam direction for use, by the UE 110, when transmitting to the TRP 170 when the UE 110 is in the future location. On the basis of trends recognized in the analyzing (step 2112), the TRP 170 may predict that the quality of the communication link between the TRP 170 and the UE 110 will deteriorate at a future moment, t₂. That is, a further result of the analyzing (step 2112) may be a prediction of the future moment, t₂, at which the new transmit beam direction is expected to provide a more robust communication link than the existing transmit beam direction.

Responsive to initiating (step 2114) the beam switching procedure, the TRP 170 transmits (step 2118), to the UE 110, an instruction to perform beam switching. The transmission (step 2118) of the instruction may be accomplished using a DCI on the PDCCH. The instruction may include a beam indication for a new receive beam direction for the UE 110 corresponding to the new transmit beam direction for the TRP 170 and an indication of the future time at which the switch to the new transmit beam direction will occur at the TRP 170. The instruction may also include a beam indication for the new transmit beam direction for the UE 110.

The indication of the future time may take the form of a time offset (Δt). The future moment, t₂, at which the new transmit beam directions are to be employed by the TRP 170 and the UE 110 may be determined, at the UE 110, by combining the time offset, Δt, which has been received (step 2120) as part of the beam switching instruction, with a reference time point, t_{ref}. The reference time point, t_{ref}, allows both the TRP 170 and the UE 110 to determine the same moment, t₂=t_{ref}+Δt, for the switch to the new transmit beam direction. The reference time point, t_{ref}, may be pre-configured at both the TRP 170 and the UE 110. Alternatively, the reference time point, t_{ref}, may be transmitted (step 2118) as part of the beam switching instruction.

The instruction may indicate the new beam directions using a coordinate-based beam indication. The instruction may indicate the new receive beam directions as absolute beam directions by using coordinates. Alternatively, the instruction may indicate the new receive beam directions using differential representation of the new receive beam directions in the context of a reference beam direction by using differential coordinates. The reference beam direction may be related to the beam direction used, by the TRP 170, to transmit (step 2102) the sensing signals.

Notably, the new transmit beam may not be transmitted (step 2122) by the TRP 170. Indeed, the new transmit beam may be transmitted (step 2122) by a distinct TRP 170 defining a neighboring cell.

Typically, but not always, the TRP 170 will select (part of step 2112) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam direction may not be selected (part of step 2112) from among the transmit beam directions in the pre-configured transmit beam pool.

Responsive to receiving (step 2120) the beam switching instruction, the UE 110 may transmit (step 2121) an acknowledgement (e.g., a HARQ ACK) to the TRP 170 to acknowledge receipt of the switching instruction.

Subsequent to transmitting (step 2118) the beam switching instruction, the TRP 170 may wait until the specified future moment, t₂, or the specified moment at which PDSCH and/or PDCCH and/or CSI-RS is/are transmitted after the future moment, t₂, to apply the new transmit beam direction to the task of communicating (step 2122) with the UE 110 using PDSCH and/or PDCCH and/or CSI-RS.

Responsive to receiving (step 2120) the beam switching instruction, the UE 110 may wait until the specified future moment, t₂, or the specified moment at which PDSCH and/or PDCCH and/or CSI-RS is/are transmitted after the future moment, t₂, to apply the new receive beam direction to the task of receiving (step 2124) the communication from the TRP 170.

Similarly, the TRP 170 may wait until the specified future moment, t₂, or the specified moment at which PUSCH and/or PUCCH and/or SRS is/are transmitted after the future moment, t₂, to apply the new receive beam direction to the task of communicating (step 2128) with the UE 110 using PUSCH and/or PUCCH and/or SRS.

Additionally, the UE 110 may wait until the specified future moment, t₂, or the specified moment at which PUSCH and/or PUCCH and/or SRS is/are transmitted after the future moment, t₂, to apply the new transmit beam direction to the task of transmitting (step 2126) the communication to the TRP 170.

For PDCCH transmission, if a PDCCH transmission (step 2122) is to be performed at the future moment, t₂, the TRP 170 is to apply the new transmit beam direction to the PDCCH transmission (step 2122) at the future moment, t₂. If a PDCCH transmission (step 2122) is to be performed after the future moment, t₂, the TRP 170 is to apply the new transmit beam direction to the PDCCH transmission (step 2122) after the future moment, t₂.

For PUCCH transmission, if a PUCCH transmission (step 2126) is to be performed at the future moment, t₂, the UE 110 is to apply the new transmit beam direction to the PUCCH transmission (step 2126) at the future moment, t₂. If a PUCCH transmission (step 2126) is to be performed after the future moment, t₂, the UE 110 is to apply the new transmit beam direction to the PUCCH transmission (step 2126) after the future moment, t₂.

For PDSCH transmission, if a PDSCH transmission (step 2122) is to be performed at the future moment, t₂, the TRP 170 is to apply the new transmit beam direction to the PDCCH transmission (step 2122) at the future moment, t₂. If a PDSCH transmission (step 2122) is to be performed after the future moment, t₂, the TRP 170 is to apply the new transmit beam direction to the PDSCH transmission (step 2122) after the future moment, t₂.

For PUSCH transmission, if a PUSCH transmission (step 2126) is to be performed at the future moment, t₂, the UE 110 is to apply the new transmit beam direction to the PUCCH transmission (step 2126) at the future moment, t₂. If a PUSCH transmission (step 2126) is to be performed after the future moment, t₂, the UE 110 is to apply the new transmit beam direction to the PUSCH transmission (step 2126) after the future moment, t₂.

For CSI-RS transmission in periodic and/or aperiodic and/or semi-persistent mode, if a CSI-RS transmission (step 2122) is to be performed at the future moment, t₂, the TRP 170 is to apply the new transmit beam direction to the CSI-RS transmission (step 2122) at the future moment, t₂. If a CSI-RS transmission (step 2122) is to be performed after the future moment, t₂, the TRP 170 is to apply the new transmit beam direction to the CSI-RS transmission (step 2122) after the future moment, t₂.

For SRS transmission in periodic and/or aperiodic and/or semi-persistent mode, if a SRS transmission (step 2126) is to be performed at the future moment, t₂, the UE 110 is to apply the new transmit beam direction to the SRS transmission (step 2126) at the future moment, t₂. If an SRS transmission (step 2126) is to be performed after the future moment, t₂, the UE 110 is to apply the new transmit beam direction to the SRS transmission (step 2126) after the future moment, t₂.

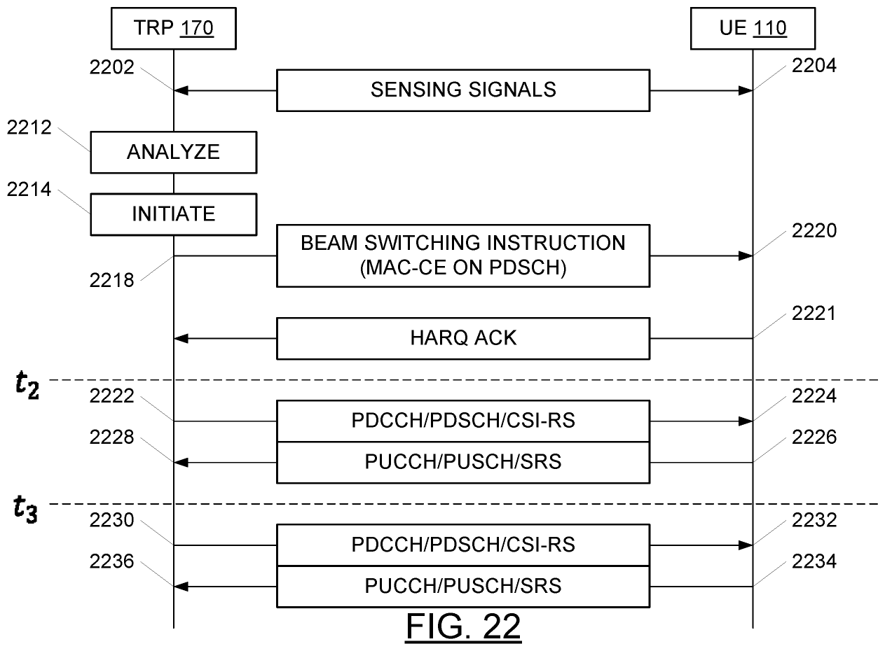

FIG. 22 illustrates, in a signal flow diagram, a beam switching procedure in accordance with aspects of the present application.

In this embodiment, one indication signaling is transmitted to indicate subsequent beam directions that changes with time in a subsequent period of time. And the one indication signaling is transmitted to simultaneously indicate multiple uplink and/or downlink channels/signals.

In one approach to the use of sensing signals, the TRP 170 or the UE 110 transmits (step 2202) sensing signals. The another device, the TRP 170 or the UE 110, then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 2204) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 2202 and step 2204 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 2212) versions of the sensed environment obtained through temporally separated transmissions (steps 1702 and/or 1704) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 2212) obtaining information about the present location of the UE 110 and past locations of the UE 110, the TRP 170 may use the analyzing (step 2212) to attempt to predict a future location for the UE 110. It is in the attempt to predict a future location for the UE 110 that the TRP may employ AI technology. One result of the analyzing (step 2212) may be multiple future locations for the UE 110. Another result of the analyzing (step 2212) may be a selection of multiple new transmit beam directions for use, by the TRP 170, when transmitting to the UE 110 when the UE 110 is in the future locations. A further result of the analyzing (step 2212) may be a selection of a new transmit beam direction for use, by the UE 110, when transmitting to the TRP 170 when the UE 110 is in the future locations. On the basis of trends recognized in the analyzing (step 2212), the TRP 170 may predict that the quality of the communication link between the TRP 170 and the UE 110 will deteriorate at a future moment, t₂. That is, a further result of the analyzing (step 2212) may be a prediction of the future moment, t₂, at which a first one of the new transmit beam directions is expected to provide a more robust communication link than the existing transmit beam direction.

Responsive to initiating (step 2214) the beam switching procedure, the TRP 170 transmits (step 2218), to the UE 110, an instruction to perform beam switching. The transmission (step 2218) of the instruction may be accomplished using a MAC-CE on the PDSCH.

The signal flow of FIG. 20 applies to scenarios wherein the UE 110 moves so fast that the transmit beam direction, at the TRP 170, may benefit from quickly switching in a short period of time. In the signal flow of FIG. 11, the beam switching instruction transmitted in step 1118 included a single new beam direction and a single indication of a future moment at which the single new beam direction is to be applied. In contrast, in the signal flow of FIG. 22, the beam switching instruction transmitted in step 2218 includes multiple new beam directions and multiple indications of future moments at which an individual new beam direction, among the multiple new beam directions, is to be applied.

Rather than include a single beam indication for a new receive beam direction corresponding to the new transmit beam direction and an indication of the future time at which the switch to the new transmit beam direction will occur at the TRP 170, the instruction may include a plurality of beam indications for new receive beam directions corresponding to the plurality of new transmit beam directions and an indication of the plurality of future times at which the switch to respective new transmit beam directions will occur at the TRP 170.

Rather than indicate a plurality of distinct receive beam directions, the instruction may include an indication of a pattern representative of a plurality of distinct receive beam directions. Furthermore, rather than indicating a plurality of future times, the instruction may include a reference to a start time and time duration of each distinct receive beam direction.

The indication of the future moment, or the start time, may take the form of a time offset (Δt). The future moment or start time, t₂, at which the first new transmit beam direction is to be employed by the TRP 170 and the UE 110 may be determined, at the UE 110, by combining the time offset, Δt, which has been received (step 2220) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 2218) as part of the beam switching instruction.

The instruction may indicate the plurality of new receive beam directions using a coordinate-based beam indication. The instruction may indicate the new receive beam directions as absolute beam directions by using coordinates. Alternatively, the instruction may indicate the new receive beam directions using a differential representation of the new receive beam directions in the context of a reference beam direction by using differential coordinates. The reference beam direction may be related to the beam direction used, by the TRP 170, to transmit (step 2202) the sensing signals.

Notably, the new transmit beams may not be transmitted (step 2222) by the TRP 170. Indeed, the new transmit beams may be transmitted (step 2222) by a distinct TRP 170 defining a neighboring cell.

Typically, but not always, the TRP 170 will select (part of step 2212) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 2212) from among the transmit beam directions in the pre-configured transmit beam pool.

Responsive to receiving (step 2220) the beam switching instruction, the UE 110 may transmit (step 2221) an acknowledgement (e.g., a HARQ ACK) to the TRP 170 to acknowledge receipt of the switching instruction.

Subsequent to transmitting (step 2218) the beam switching instruction, the TRP 170 may wait until the specified future moment, t₂, or the specified moment at which PDSCH and/or PDCCH and/or CSI-RS is/are transmitted after the future moment, t₂, to apply the new transmit beam direction to the task of communicating (step 2222) with the UE 110 using PDSCH and/or PDCCH and/or CSI-RS.

Responsive to receiving (step 2220) the beam switching instruction, the UE 110 may wait until the specified future moment, t₂, or the specified moment at which PDSCH and/or PDCCH and/or CSI-RS is/are transmitted after the future moment, t₂, to apply the new receive beam direction to the task of receiving (step 2224) the communication from the TRP 170.

Similarly, the TRP 170 may wait until the specified future moment, t₂, or the specified moment at which PUSCH and/or PUCCH and/or SRS is/are transmitted after the future moment, t₂, to apply the new receive beam direction to the task of communicating (step 2228) with the UE 110 using PUSCH and/or PUCCH and/or SRS.

Additionally, the UE 110 may wait until the specified future moment, t₂, or the specified moment at which PUSCH and/or PUCCH and/or SRS is/are transmitted after the future moment, t₂, to apply the new transmit beam direction to the task of transmitting (step 2226) the communication to the TRP 170.

The TRP 170 may then wait until a next moment, t₃, or the specified moment at which PDSCH and/or PDCCH and/or CSI-RS is/are transmitted after the future moment, t₃, to apply a next new transmit beam direction to the task of communicating (step 2230) with the UE 110 using PDSCH and/or PDCCH and/or CSI-RS.

The UE 110 may then wait until the next moment, t₃, or the specified moment at which PDSCH and/or PDCCH and/or CSI-RS is/are transmitted after the future moment, t₃, to apply the next new receive beam direction to the task of receiving (step 2232) the communication from the TRP 170.

Similarly, the TRP 170 may wait until the specified future moment, t₃, or the specified moment at which PUSCH and/or PUCCH and/or SRS is/are is transmitted after the future moment, t₃, to apply the new receive beam direction to the task of communicating (step 2236) with the UE 110 using PUSCH and/or PUCCH and/or SRS.

Additionally, the UE 110 may wait until the specified future moment, t₃, or the specified moment at which PUSCH and/or PUCCH and/or SRS is/are transmitted after the future moment, t₃, to apply the new transmit beam direction to the task of transmitting (step 2234) the communication to the TRP 170.

If a PDCCH transmission is to be performed at the future moment, t₂, the TRP 170 is to apply the new transmit beam direction to the PDCCH transmission (step 2222) at the future moment, t₂. If a PDCCH transmission is to be performed after the future moment, t₂, the TRP 170 is to determine the new transmit beam direction that is associated with the future moment and apply the determined new transmit beam direction to the PDCCH transmission after the future moment, t₂.

If a PUCCH transmission is to be performed at the future moment, t₂, the UE 110 is to apply the new transmit beam direction to the PUCCH transmission (step 2226) at the future moment, t₂. If a PUCCH transmission is to be performed after the future moment, t₂, the TRP 170 is to determine the new transmit beam direction that is associated with the future moment and apply the determined new transmit beam direction to the PUCCH transmission after the future moment, t₂.

If a PDSCH transmission is to be performed at the future moment, t₂, the TRP 170 is to apply the new transmit beam direction to the PDSCH transmission (step 2222) at the future moment, t₂. If a PDSCH transmission (step 2222) is to be performed after the future moment, t₂, the TRP 170 is to determine the new transmit beam direction that is associated with the future moment and apply the determined new transmit beam direction to the PDSCH transmission after the future moment, t₂.

If a PUSCH transmission is to be performed at the future moment, t₂, the UE 110 is to apply the new transmit beam direction to the PDSCH transmission (step 2226) at the future moment, t₂. If a PUSCH transmission (step 2222) is to be performed after the future moment, t₂, the UE 110 is to determine the new transmit beam direction that is associated with the future moment and apply the determined new transmit beam direction to the PUSCH transmission after the future moment, t₂.

For CSI-RS transmission in periodic and/or aperiodic and/or semi-persistent mode, if a CSI-RS transmission is to be performed at the future moment, t₂, the TRP 170 is to apply the new transmit beam direction to the CSI-RS transmission (step 2222) at the future moment, t₂. If a CSI-RS transmission (step 2222) is to be performed after the future moment, t₂, the TRP 170 is to determine the new transmit beam direction that is associated with the future moment and apply the determined new transmit beam direction to the CSI-RS transmission after the future moment, t₂.

For SRS transmission in periodic and/or aperiodic and/or semi-persistent mode, if a SRS transmission is to be performed at the future moment, t₂, the UE 110 is to apply the new transmit beam direction to the SRS transmission (step 2226) at the future moment, t₂. If a SRS transmission (step 2226) is to be performed after the future moment, t₂, the UE 110 is to determine the new transmit beam direction that is associated with the future moment and apply the determined new transmit beam direction to the SRS transmission after the future moment, t₂.

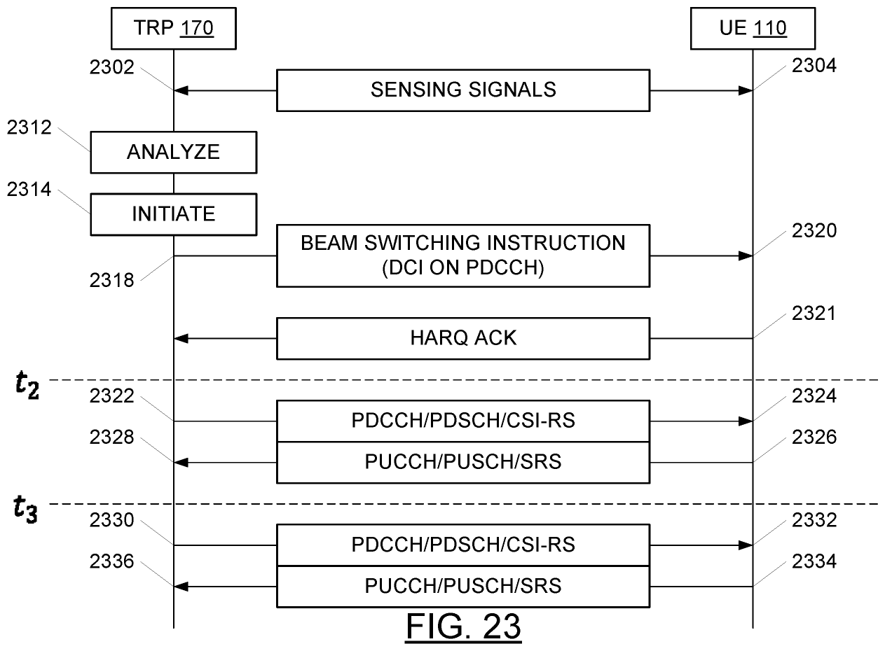

FIG. 23 illustrates, in a signal flow diagram, a beam switching procedure in accordance with aspects of the present application.

In this embodiment, one indication signaling is transmitted to indicate subsequent beam directions that changes with time in a subsequent period of time. And the one indication signaling is transmitted to simultaneously indicate multiple uplink and/or downlink channels/signals.

In one approach to the use of sensing signals, the TRP 170 or the UE 110 transmits (step 2302) sensing signals. The another device, the TRP 170 or the UE 110, then analyzes reflections of the sensing signals to obtain information about the environment in which both the TRP 170 and the UE 110 are operating. This approach is sometimes known as mono-static sensing, since the sending of the sensing signals and the analysis of the reflections of the sensing signals both take place at a single device, the TRP 170 or the UE 110.

In another approach to the use of sensing signals, the UE 110 or the TRP 170 transmits (step 2304) sensing signals. The another device, the TRP 170 or the UE 110, then analyzes reflections of the sensing signals to obtain information about the environment in which both the TRP 170 and the UE 110 are operating. This approach is sometimes known as bi-static sensing, since the sending of the sensing signals takes place at one device (the UE 110 or the TRP 170) and the analysis of the reflections of the sensing signals takes place at another device (the TRP 170 or the UE 110).

Step 2302 and step 2304 may be considered optional, since the beam direction could be obtained not only based on the sensing signal but also based on other approaches, for example, based on channel measurements for initial access and/or based on channel monitoring after initial access, or based on channel inferring by AI technologies from the historical channel data of the wireless network.

By analyzing (step 2312) versions of the sensed environment obtained through temporally separated transmissions (steps 2002 and/or 2004) of sensing signals, the TRP 170 may monitor changes in the location of the UE 110. Notably, the TRP 170 may not be able to directly monitor changes in the location of the UE 110. However, the TRP 170 may be able to directly monitor changes in the location of a target (e.g., a car) and the TRP 170 may maintain an association between the target and the UE 110.

In addition to the analyzing (step 2312) obtaining information about the present location of the UE 110 and past locations of the UE 110, the TRP 170 may use the analyzing (step 2312) to attempt to predict a future location for the UE 110. It is in the attempt to predict a future location for the UE 110 that the TRP may employ AI technology. One result of the analyzing (step 2312) may be multiple future locations for the UE 110. Another result of the analyzing (step 2312) may be a selection of multiple new transmit beam directions for use, by the TRP 170, when transmitting to the UE 110 when the UE 110 is in the future locations. A further result of the analyzing (step 2312) may be a selection of a new transmit beam direction for use, by the UE 110, when transmitting to the TRP 170 when the UE 110 is in the future locations. On the basis of trends recognized in the analyzing (step 2312), the TRP 170 may predict that the quality of the communication link between the TRP 170 and the UE 110 will deteriorate at a future moment, t₂. That is, a further result of the analyzing (step 2312) may be a prediction of the future moment, t₂, at which a first one of the new transmit beam directions is expected to provide a more robust communication link than the existing transmit beam direction.

Responsive to initiating (step 2314) the beam switching procedure, the TRP 170 transmits (step 2318), to the UE 110, an instruction to perform beam switching. The transmission (step 2318) of the instruction may be accomplished using a DCI on the PDCCH.

The signal flow of FIG. 23 applies to scenarios wherein the UE 110 moves so fast that the transmit beam direction, at the TRP 170, may benefit from quickly switching in a short period of time. In the signal flow of FIG. 11, the beam switching instruction transmitted in step 1118 included a single new beam direction and a single indication of a future moment at which the single new beam direction is to be applied. In contrast, in the signal flow of FIG. 23, the beam switching instruction transmitted in step 2318 includes multiple new beam directions and multiple indications of future moments at which an individual new beam direction, among the multiple new beam directions, is to be applied.

Rather than include a single beam indication for a new receive beam direction corresponding to the new transmit beam direction and an indication of the future time at which the switch to the new transmit beam direction will occur at the TRP 170, the instruction may include a plurality of beam indications for new receive beam directions corresponding to the plurality of new transmit beam directions and an indication of the plurality of future times at which the switch to respective new transmit beam directions will occur at the TRP 170.

Rather than indicate a plurality of distinct receive beam directions, the instruction may include an indication of a pattern representative of a plurality of distinct receive beam directions. Furthermore, rather than indicating a plurality of future times, the instruction may include a reference to a start time and time duration of each distinct receive beam direction.

The indication of the future moment, or the start time, may take the form of a time offset (Δt). The future moment or start time, t₂, at which the first new transmit beam direction is to be employed by the TRP 170 and the UE 110 may be determined, at the UE 110, by combining the time offset, Δt, which has been received (step 2320) as part of the beam switching instruction, with a reference time point, t_{ref}. The reference time point, t_{ref}, allows both the TRP 170 and the UE 110 to determine the same moment, t₂=t_{ref}+Δt, for the switch to the first new transmit beam direction. The reference time point, t_{ref}, may be pre-configured at both the TRP 170 and the UE 110. Alternatively, the reference time point, t_{ref}, may be transmitted (step 2318) as part of the beam switching instruction.

The instruction may indicate the plurality of new receive beam directions using a coordinate-based beam indication. The instruction may indicate the new receive beam directions as absolute beam directions by using coordinates. Alternatively, the instruction may indicate the new receive beam directions using a differential representation of the new receive beam directions in the context of a reference beam direction by using differential coordinates. The reference beam direction may be related to the beam direction used, by the TRP 170, to transmit (step 2302) the sensing signals.

Notably, the new transmit beams may not be transmitted (step 2322) by the TRP 170. Indeed, the new transmit beams may be transmitted (step 2322) by a distinct TRP 170 defining a neighboring cell.

Typically, but not always, the TRP 170 will select (part of step 2312) the new transmit beam directions from among a range of transmit beam directions. Each discrete transmit beam direction in such a range of beam directions may be considered to be part of a beam pool. The range of transmit beam directions may be determined, by the TRP 170, through the use of sensing signals. Accordingly, the TRP 170 may be considered to have a pre-configured transmit beam pool. It is notable that the new transmit beam directions may not be selected (part of step 2312) from among the transmit beam directions in the pre-configured transmit beam pool.

Responsive to receiving (step 2320) the beam switching instruction, the UE 110 may transmit (step 2321) an acknowledgement (e.g., a HARQ ACK) to the TRP 170 to acknowledge receipt of the switching instruction.

Subsequent to transmitting (step 2318) the beam switching instruction, the TRP 170 may wait until the specified future moment, t₂, or the specified moment at which PDSCH and/or PDCCH and/or CSI-RS is/are transmitted after the future moment, t₂, to apply the new transmit beam direction to the task of communicating (step 2322) with the UE 110 using PDSCH and/or PDCCH and/or CSI-RS.

Responsive to receiving (step 2320) the beam switching instruction, the UE 110 may wait until the specified future moment, t₂, or the specified moment at which PDSCH and/or PDCCH and/or CSI-RS is/are transmitted after the future moment, t₂, to apply the new receive beam direction to the task of receiving (step 2324) the communication from the TRP 170.

Similarly, the TRP 170 may wait until the specified future moment, t₂, or the specified moment at which PUSCH and/or PUCCH and/or SRS is/are transmitted after the future moment, t₂, to apply the new receive beam direction to the task of communicating (step 2328) with the UE 110 using PUSCH and/or PUCCH and/or SRS.

Additionally, the UE 110 may wait until the specified future moment, t₂, or the specified moment at which PUSCH and/or PUCCH and/or SRS is/are transmitted after the future moment, t₂, to apply the new transmit beam direction to the task of transmitting (step 2326) the communication to the TRP 170.

The TRP 170 may then wait until a next moment, t₃, or the specified moment at which PDSCH and/or PDCCH and/or CSI-RS is/are transmitted after the future moment, t₃, to apply a next new transmit beam direction to the task of communicating (step 2330) with the UE 110 using PDSCH and/or PDCCH and/or CSI-RS.

The UE 110 may then wait until the next moment, t₃, or the specified moment at which PDSCH and/or PDCCH and/or CSI-RS is/are transmitted after the future moment, t₃, to apply the next new receive beam direction to the task of receiving (step 2332) the communication from the TRP 170.

Similarly, the TRP 170 may wait until the specified future moment, t₃, or the specified moment at which PUSCH and/or PUCCH and/or SRS is/are transmitted after the future moment, t₃, to apply the new receive beam direction to the task of communicating (step 2336) with the UE 110 using PUSCH and/or PUCCH and/or SRS.

Additionally, the UE 110 may wait until the specified future moment, t₃, or the specified moment at which PUSCH and/or PUCCH and/or SRS is/are transmitted after the future moment, t₃, to apply the new transmit beam direction to the task of transmitting (step 2334) the communication to the TRP 170.

If a PDCCH transmission is to be performed at the future moment, t₂, the TRP 170 is to apply the new transmit beam direction to the PDCCH transmission (step 2322) at the future moment, t₂. If a PDCCH transmission is to be performed after the future moment, t₂, the TRP 170 is to determine the new transmit beam direction that is associated with the future moment and apply the determined new transmit beam direction to the PDCCH transmission after the future moment, t₂.

If a PUCCH transmission is to be performed at the future moment, t₂, the UE 110 is to apply the new transmit beam direction to the PUCCH transmission (step 2326) at the future moment, t₂. If a PUCCH transmission is to be performed after the future moment, t₂, the TRP 170 is to determine the new transmit beam direction that is associated with the future moment and apply the determined new transmit beam direction to the PUCCH transmission after the future moment, t₂.

If a PDSCH transmission is to be performed at the future moment, t₂, the TRP 170 is to apply the new transmit beam direction to the PDSCH transmission (step 2322) at the future moment, t₂. If a PDSCH transmission (step 2322) is to be performed after the future moment, t₂, the TRP 170 is to determine the new transmit beam direction that is associated with the future moment and apply the determined new transmit beam direction to the PDSCH transmission after the future moment, t₂.

If a PUSCH transmission is to be performed at the future moment, t₂, the UE 110 is to apply the new transmit beam direction to the PDSCH transmission (step 2326) at the future moment, t₂. If a PUSCH transmission (step 2322) is to be performed after the future moment, t₂, the UE 110 is to determine the new transmit beam direction that is associated with the future moment and apply the determined new transmit beam direction to the PUSCH transmission after the future moment, t₂.

For CSI-RS transmission in periodic and/or aperiodic and/or semi-persistent mode, if a CSI-RS transmission is to be performed at the future moment, t₂, the TRP 170 is to apply the new transmit beam direction to the CSI-RS transmission (step 2322) at the future moment, t₂. If a CSI-RS transmission (step 2322) is to be performed after the future moment, t₂, the TRP 170 is to determine the new transmit beam direction that is associated with the future moment and apply the determined new transmit beam direction to the CSI-RS transmission after the future moment, t₂.

For SRS transmission in periodic and/or aperiodic and/or semi-persistent mode, if a SRS transmission is to be performed at the future moment, t₂, the UE 110 is to apply the new transmit beam direction to the SRS transmission (step 2326) at the future moment, t₂. If a SRS transmission (step 2326) is to be performed after the future moment, t₂, the UE 110 is to determine the new transmit beam direction that is associated with the future moment and apply the determined new transmit beam direction to the SRS transmission after the future moment, t₂.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A device comprising:
a memory storing instructions; and
a processor configured, by executing the instructions, to:
transmit a beam switching instruction, the beam switching instruction including:
an indication of a first beam direction for a physical channel, the indication using coordinate information, the coordinate information expressed relative to a predefined coordinate system; and
a time offset indication allowing for a determination of a future moment;
communicate, before the future moment, using a second beam direction; and
communicate, after the future moment, using a third beam direction, the third beam direction corresponding to the first beam direction.

2. The device of claim 1, wherein the physical channel comprises a physical downlink channel and the first beam direction comprises a receive beam direction, or the physical channel comprises a physical uplink channel and the first beam direction comprises a transmit beam direction.

3. The device of claim 1, wherein the coordinate information comprises differential coordinates relative to a reference beam direction.

4. The device of claim 3, wherein the reference beam direction comprises coordinates of a sensing beam direction.

5. The device of claim 1, wherein the beam switching instruction further includes an indication of a reference time point, or an indication of a plurality of beam directions for the physical channel.

6. The device of claim 5, wherein the processor is further configured, by executing the instructions, to express the indication of the plurality of beam directions as a pattern.

7. The device of claim 5, wherein the beam switching instruction further includes, for each beam direction in the plurality of beam directions, an indication of a respective start time and a respective duration.

8. The device of claim 1, wherein the processor further configured, by executing the instructions, to obtain a range of beam directions through sensing.

9. The device of claim 1, wherein the processor further configured, by executing the instructions, to:
receive reflections of sensing signals;
perform an analysis of the reflections; and
determine, based on the analysis, the third beam direction.

10. A method comprising:
transmitting a beam switching instruction, the beam switching instruction including:
an indication of a first beam direction for a physical channel, the indication using coordinate information, the coordinate information expressed relative to a predefined coordinate system; and
a time offset indication allowing for a determination of a future moment;
communicating, before the future moment, using a second beam direction; and
communicating, after the future moment, using a third beam direction, the third beam direction corresponding to the first beam direction.

11. A device comprising:
a memory storing instructions; and
a processor configured, by executing the instructions, to:
receive a beam switching instruction, the beam switching instruction including:
an indication of a first beam direction for a physical channel, the indication using coordinate information, the coordinate information expressed relative to a predefined coordinate system; and
a time offset indication allowing for a determination of a future moment;
communicate before the future moment, using a second beam direction; and
communicate, after the future moment, using a third beam direction, the third beam direction corresponding to the first beam direction.

12. The device of claim 11, wherein the coordinate information comprises absolute coordinate information.

13. The device of claim 11, wherein the coordinate information comprises differential coordinates relative to a reference beam direction.

14. The device of claim 13, wherein the reference beam direction comprises coordinates of a sensing beam direction.

15. The device of claim 11, wherein the beam switching instruction further includes an indication of a reference time point.

16. The device of claim 11, wherein the beam switching instruction further includes an indication of a plurality of beam directions for the physical channel.

17. The device of claim 16, wherein the beam switching instruction further includes, for each beam direction in the plurality of beam directions, an indication of a respective start time and a respective duration.

18. The device of claim 11, wherein the processor further configured, by executing the instructions, to: transmit an acknowledgement of receipt of the beam switching instruction.

19. A method comprising:
receiving a beam switching instruction, the beam switching instruction including:
an indication of a first beam direction for a physical channel, the indication using coordinate information, the coordinate information expressed relative to a predefined coordinate system; and
a time offset indication allowing for a determination of a future moment;
communicating, before the future moment, using a second beam direction; and
communicating, after the future moment, using a third beam direction, the third beam direction corresponding to the first beam direction.

20. The method according to claim 19, wherein the coordinate information comprises absolute coordinate information or differential coordinates relative to a reference beam direction.
